(19) United States
(12) Patent Application Publication
(10) Pub. No.: US 2017/0099248 A1
(43) Pub. Date: Apr. 6, 2017

(54) SYSTEMS AND METHODS FOR GENERATING A QUEUE OF MESSAGES FOR TRAMSISSION VIA A MESSAGING PROTOCOL

(71) Applicant: Familygram, Inc., Portland, OR (US)

(72) Inventor: Stephen M. Pisenti, Portland, OR (US)

(21) Appl. No.: 15/251,362

(22) Filed: Aug. 30, 2016

Related U.S. Application Data
(60) Provisional application No. 62/218,304, filed on Sep. 14, 2015.

(51) Int. Cl. H04L 12/58

(52) U.S. Cl. CPC H04L 51/22; H04L 51/08

(57) ABSTRACT

Content for a plurality of messages that are compatible with a messaging communication protocol may be used to generate a queue of messages to be sent to a recipient. In some instances, the messages may be auto-generated using content from a third party source. The messages may include enriched media objects (EMO) that may contain two or more data files, which at times, may be in different formats. In most cases, at least one of the first data file and the second data file include a media object such as an image, video recording, or audio recording.

### RELATED APPLICATIONS

This application claims the benefit of of U.S. Provisional Application No. 62/218,304 entitled “Intelligent Agent for Monitoring Senior Living” filed on Sep. 14, 2015, which is incorporated herein by reference.

### FIELD OF INVENTION

The present invention relates to an improvement in computer-related technology. More specifically, the present invention relates to systems and methods for generating, sending, receiving, displaying, and/or saving an enriched media object. The present invention also relates to systems and methods for enhancing and persisting social connectedness between individuals, systems and methods for generating and using a message queue, systems and methods for monitoring health and wellness of an individual, and a dynamic graphic user interface adapted to provide enriched media objects.

### BACKGROUND

While current text messaging allows for different types of media files to be sent in a single text message, these media files are not linked in any way other than their mutual transmission via the same message. Instead, each data file included in a message is typically interpreted by the receiving software application as a separate data file. Furthermore, the data files within a message are not persistently associated with one another. Therefore, any symbiotic relationship between the data files of a particular message may be lost if the data files become separated from one another as may be the case when, for example, data files of a particular type (e.g., photos) are saved in one location (e.g., a photo album maintained by a software application running on a receiving device) and data files of another type (e.g., text) are saved in a different location (e.g., saved in by a text messaging application) or, not saved at all as may be the case when the setting of a device and/or software application that receives messages automatically deletes messages that are of a certain age.

### SUMMARY

Disclosed herein are systems and methods for generating, displaying, and saving an enriched media object (EMO). An EMO may contain two or more data files, which at times, may be in different formats. A first data file and a second data file may be received. In most cases, at least one of the first data file and the second data file include a media object such as an image, video recording, or audio recording. The first data file and second data file may then be encapsulated into a single enriched media object. Often times, the enriched media object is compatible with a messaging communication protocol such as the Short Message Service (SMS) communication protocol. In some instances, the enriched media object may be communicated to a recipient device and/or a user device using the messaging communication protocol. At times, the enriched media object may be stored in a data structure as a single enriched media object file.

In some embodiments, the first and second data files may be related or associated with one another. For example, second data file may contain content that describes the first data file as may be the case when the first data file is an image and the second data file is a textual description of the image.

In one embodiment, the encapsulation may include adding an identifier to the enriched media object. The identifier may be adapted to identify the enriched media object as an enriched media object.

In yet another embodiment, the enriched media object may be received by a recipient device via the messaging communication protocol and may be forwarded, as a single object, from the recipient device to another device using the messaging communication protocol.

In an additional embodiment, an enriched media object may be received at a recipient device via a messaging communication protocol. The enriched media object may include a first data file and a second data file encapsulated as a single object and at least one of the first data file and the second data file may include a media object. The first and second data files may of a different format. In some instances, the first and second data files may be associated with, or related to, one another as may be the case when the content of the first data file is described by the content of the second data file. The recipient device may then provide an icon on an interface that represents the received enriched media object, wherein selection of the icon activates display of both the first data file and the second data file. In some embodiments, the enriched media object may be perpetually stored as a single enriched media object file in a data structure. On some occasions, the enriched media object, may be communicated as a single enriched media object file, to, for example, a user device and/or a recipient device.

In some instances, the encapsulation may include adding an identifier to the enriched media object. The identifier may be adapted to identify the enriched media object as an enriched media object.

In yet another embodiment, an enriched media object may be received by a recipient device and communicated as a single enriched media object file, to a user and/or recipient device. The first and second data files may be in different formats and, in some instances may be related to, or associated with, one another. On some occasions, the enriched media object includes an identifier adapted to identify the enriched media object as an enriched media object.

The enriched media object may be stored as a single enriched media object file in a data structure and/or communicated as a single enriched media object file, to a user device.

### BRIEF DESCRIPTION OF THE DRAWINGS

The present application is illustrated by way of example, and not limitation, in the figures of the accompanying drawings, in which:

FIG. 1 is a block diagram illustrating an exemplary system in accordance with some embodiments of the present invention;

FIG. 2 is a flow chart depicting an exemplary process for building, modifying, or editing a data structure that includes a queue of messages and/or enriched media objects and providing one or more messages and/or enriched media objects in the queue to a recipient, in accordance with some embodiments of the present invention;

FIG. 3 is a flow chart depicting an exemplary process for providing one or more reminders and/or pre-configured messages to a user, such as users via a user device, in accordance with some embodiments of the present invention;

FIG. 4 is a flow chart depicting an exemplary process for monitoring a health and wellness state of an individual, in accordance with some embodiments of the present invention;

FIG. 5 is a flow chart depicting an exemplary process for extracting EMOs from a text message stream and generating/modifying/updating a data structure that stores EMOs according to one or more criteria, in accordance with some embodiments of the present invention;

FIGS. 6A-I, 7A-D, 8A-B and 9-28 are screen shots various interfaces, in accordance with some embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### WRITTEN DESCRIPTION

Disclosed herein are methods for generating, storing, and communicating enriched media objects, or “EMO”s. An EMO is a data file that encapsulates, or links, together two or more data files so that the two or more files included in an EMO may be perceived as a single object by, for example, a computer system or a software application that provides access to and/or storage of the EMO. Because the two or more data files included in an EMO are stored in a persistent state and perceived as a single object by a receiving device, an EMO may be perpetually communicated, stored, accessed, viewed, and/or manipulated as a single object without any further intervention or management.

EMOs may be generated so that they are compatible with communication via a text-based software application, an online chat or instant messaging protocol (e.g., GOOGLE TALK™, APPLE MESSAGES™, WHATSAPP™, Internet Relay Chat (IRC)), a multimedia messaging service (MMS) communication protocol, and/or a text messaging communications protocol utilized by mobile communications systems (e.g., Short Messaging Service (SMS)). For ease of discussion, these text-based software applications may be referred to herein as a “messaging communication protocol” and messages sent via these text-based software application may be referred to herein as “text message” whether they contain actual text, or not.

EMOs may be perceived by a communication vehicle (e.g., computer, mobile phone, smart phone, tablet, etc.) as a single data file, as opposed to two separate data files sent at the same time (as may be the case when, for example, a picture and a written statement are sent via a single SMS text message).

In some embodiments, a format for a first data file of an EMO is different from a format for a second data file of the EMO but, this need not necessarily be the case. Exemplary formats for data files included in an EMO include, but are not limited to PDF, JPEG, WAV, AIFF, RTF, Microsoft Word documents, etc. Often times, a first data file included in an EMO describes, or in some way augments the consumption of, a second media file included in the EMO. For example, and EMO may include an image data file in a PDF format and an audio file in a WAV format. The audio file may, for example, explain subject matter of the image file or provide details regarding the image file (e.g., names of people shown in the image file, a date the video file was recorded, etc.).

FIG. 18 provides a display 1800 of an exemplary EMO that includes multiple types of data files as may be seen on, for example, a recipient device. Display 1800 provides a display of an image file (i.e., the image of the girl on the beach) 1805, an icon 1810 that, when selected, provides access to an audio file associated with the image 1805, and a textual message 1815 associated with image 1805 and/or the audio file, all of which are included in the exemplary EMO.

In some embodiments, an EMO may contain structural information regarding how to organize and present these data files to a recipient in a user interface. For example, an EMO may be a structured object, such as an XML file, that provides links to the two or more data files data files of the EMO or embeds the two or more data files into the EMO data file itself. Thus, from a programming sense, this EMO object, or EMO data file, may be communicated as a single file along with other files that are associated with the EMO so that a recipient can view, store, and/or retrieve the entire EMO and render it properly to the recipient via a user interface.

In some embodiments, EMOs may be tagged, or otherwise associated with an identifier, so that they may be recognized as EMOs by a software application running on, for example, a computer device or mobile phone. For ease of discussion, the recognition mechanism for an EMO may be referred to herein as an “EMO tag.” An EMO tag may be used to identify that the object is an EMO and may be handled like any “new” file type. On a PC, an EMO tag may be a file extension used by the PC operating system to figure out what software application should be used to interact with the contents of the EMO file. Other mechanisms of generating and/or using EMO tags may employ an XML file. In some embodiments, use of an XML file as an EMO tag may require use of an software application specifically designed to receive or display EMOs, wherein the software application may point to these XML files and data files associated with an EMO.

In some circumstances, a receiving device may provide, for example, a visual indicator on, or near, the EMO as provided by a display device. The visual indicator may serve to notify a recipient that the received message is an EMO and not just a regular text message. In other circumstances, an EMO may be distinguished from, for example, a traditional text message because it contains more information than a regular text message.

EMOs may be transmitted and displayed in a stream of, for example, SMS text messages, chat messages, or instant messages. For ease of discussion, this stream of messages may be referred to herein as a “stream of text messages” and the messages in the stream may be referred to herein as “text messages.” At times, an identifier for the EMO, or EMO tag may also be displayed so that a recipient is aware that the data files that make up the EMO are connected. In some instances, activation of the icon may provide access to one or more of the data files included in the EMO. For example, when an EMO includes a picture and an audio file, selection of the icon and/or picture may provide access to (i.e., initiate the playing of) the audio file.

FIGS. 7A-7D provide exemplary text messaging interfaces 700, 701, 702, and 703, respectively, that show EMOs in an expanded state 710 and/or a minimized state 740. More specifically, the text messaging interface 700 of FIG. 7A provides an exemplary text messaging interface that shows a communication stream between a user and a recipient (in this case, Robert) from the point of view of the user. Messaging interface 700 provides an indicator 705 of a recipient for the messaging stream (in this case, Robert) is provided by the messaging interface 700. Indicator 705 may be, for example, a picture or text (e.g., name or initials). EMOs displayed in an expanded state may be displayed as a larger EMO on an interface and may provide more information about an EMO. For example, text messaging interface 700 provides an EMO in an expanded state 710 that includes a video file icon 730, two images 725, an audio file icon 720, a written message 715, and a plurality of EMOs in a minimized state 740. EMOs displayed in a minimized state may provide a brief indication of information, data, images, etc. associated with the minimized EMO. For example, the minimized EMOs 740 of interface 700 provides a relatively small image as well as a few words of text that represents the respective EMO.

FIG. 7B provides an exemplary text messaging interface 701 that shows a communication stream between a user (an image of whom is shown in indicator 705) from the point of view of the user and a plurality of minimized EMOs 740. Messaging interface 701 also provides expanded state EMO 710 that includes a video file icon 730, two images 725, an audio file icon 720, and a written message 715.

Messaging interface 702 of FIG. 7C shows a communication stream between a user and a recipient (in this case, Robert) from the point of view of the user Text messaging interface 702 provides an indicator 705 of whose text messaging stream is provided by the text messaging interface 700 and a plurality of minimized EMOs 740. Text messaging interface 702 also provides an EMO in an expanded state 710 that includes a video file icon 730, an audio file icon 720, and a written message 715.

Text messaging interface 703 of FIG. 7D shows a communication stream between a user and a recipient that shows a plurality of minimized EMOs 740. In some embodiments, a recipient and/or user may use interfaces 700, 701, 702, and/or 703 by scrolling through a series of EMOs and/or other messages so that an EMO positioned at, for example, a upper portion of the interface may be in an expanded state and all of the other messages and/or EMOs provided by the interface are provided in a minimized state below the expanded EMO.

Display of minimized EMOs 740 as shown in interface 703 may be useful when, for example, scrolling through a linear flow of messages (which may extend through many, many linear feet), and as you slow down or stop the pace of scrolling, then the EMO positioned at the top of the interface may transition to the an expanded state EMO 710 as shown in interface 702 of FIG. 7C. One exemplary purpose of displaying an expanded state EMOs 710 and minimized EMOs 740 in this manner is that it allows for faster scrolling through a message stream to assist a recipient and/or user in locating a specific EMO where only the fragment of the EMO (e.g., photo or a few words of text) is sufficient to identify it. Thus, displaying EMOs in an expanded and minimized state as shown and described herein provides a user and/or recipient with a more efficient and pleasant user experience when reviewing previously received EMOS because, for example, he or she can quickly an easily scroll through previously received EMOs to find a particular EMO of interest

It is important to note that although the text messaging interfaces 700, 701, 702, and 703 provide EMOs in a minimized and expanded state, using expanded and minimized messages in the manner shown in FIGS. 7A-7D is not limited to the display of EMOs and may, instead, be used for the display of, for example, SMS text messages, images, MMS messages, and combinations of same. Also, the embodiment of text messaging interfaces 700, 701, 702, and 703 is not limited to the display of EMOs and may be used for the display of standard text messages, messages that include images or media other than text, or MMS messages.

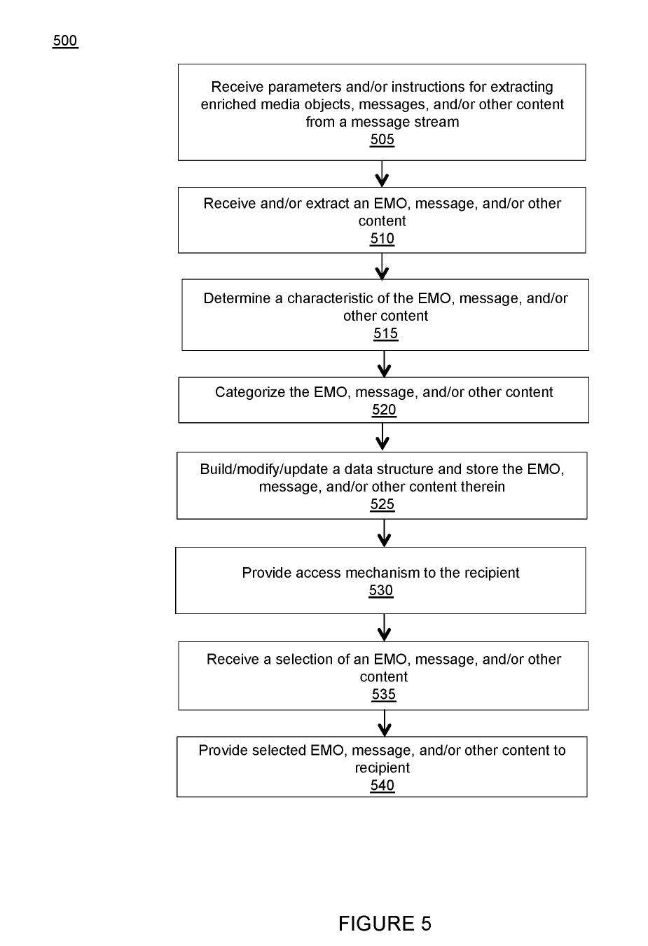

FIG. 15 provides another text messaging interface 1500 that displays a number of messages 1505, a message with an image 1510, and an EMO 1515. In some embodiments, icons, or graphic elements (e.g., images or text) such as thumbnails that represent EMOs may be displayed on an interface provided by, for example, the recipient device and/or user device. An exemplary interface displaying such icons 1705 is provided by interface 1700, which is shown in FIG. 17. At times, EMOs stored on, for example, a recipient device and/or user device may be organized into one or more categories, or albums 1605, as shown in an album selection interface 1600 as provided by FIG. 16. Further details regarding the organization of EMOs will be discussed in greater detail below with regard to FIG. 5.

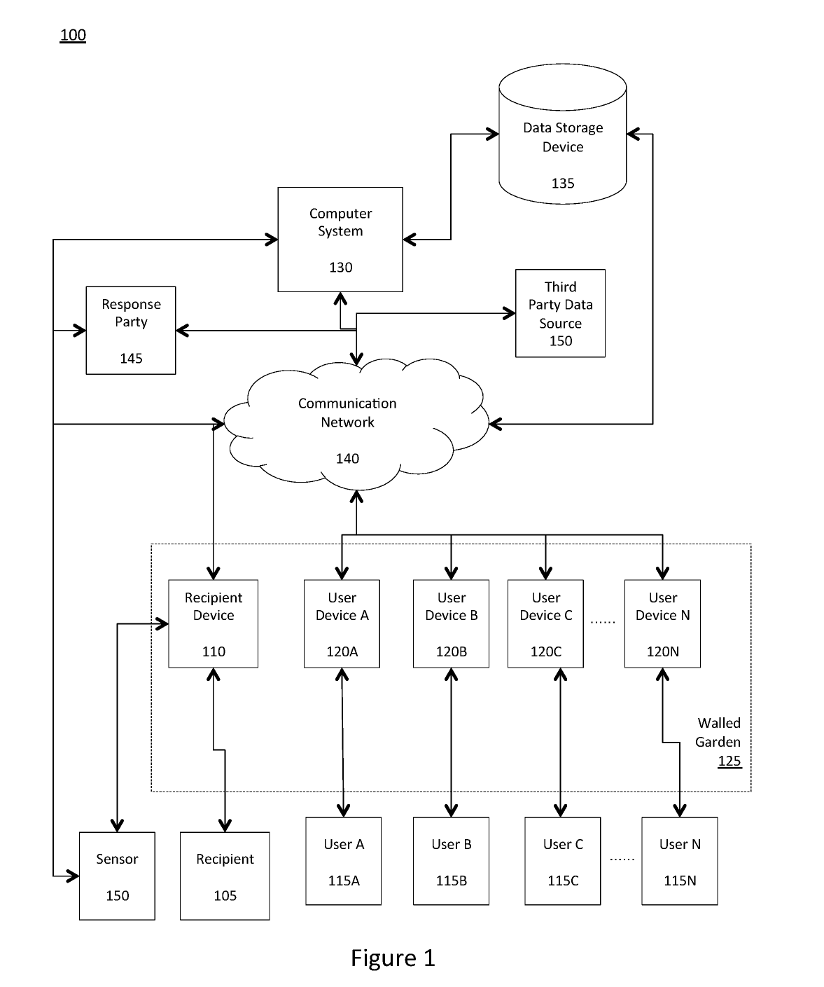

FIG. 1 provides an exemplary system 100 for generating, communicating, and/or storing an EMO. System 100 may also establish and/or maintain communications between a recipient 105 and one or more users A-N 115A-N as facilitated via a recipient device 110 and one or more user devices A-N 120. System 100 and/or a component thereof may execute one or more processes described herein.

Recipient 105 may be, for example, a target of ongoing communications for the one or more users A-N 115A-N using user devices A-N 120 and may communicate with the one or more users using their respective user devices via recipient device 110. Recipient device 110 and user devices A-N 120 may be, for example, a smart phone, a tablet computer, or a laptop or desktop computer. In most cases, recipient device 110 and user device A-N 120 will have a screen display device and be enabled to run one or more software applications, such as software applications designed to create, receive, and/or display EMOs.

In some embodiments, recipient 105 may be, for example, an individual with whom the user(s) have a cared-for/care-giver type of relationship as may exist between, for example, an elderly individual and his or her adult children, a friend, professional caregiver, or caregiving service; a school-age child and his or her parents; or a teenager away at college and his or her parents. In another embodiment, there may be no clearly established “recipient” and communication may be exchanged between all users A-N 115A-N via their respective user devices A-N 120A-120N. In this embodiment, a “recipient” as explained herein may be any user A-N 115A-N who is receiving a message and/or EMO via his or her respective user device A-N 120A-120N. In other embodiments, system 100 may have two or more recipients 105.

In some instances, a user A-N 115A-115N may use his or her user device A-N 120A-N to generate one or more EMOs via an EMO generator/editor software application program operating thereon. More specifically, the EMO generator/editor software application may allow the user to import, record, and/or capture picture/video/audio as well create/edit messages and generate an EMO therefrom. The EMO generator/editor software application may enable a user A-N 115A-115 to access one or more data files and/or software applications running on his or her user device A-N 120A-N.

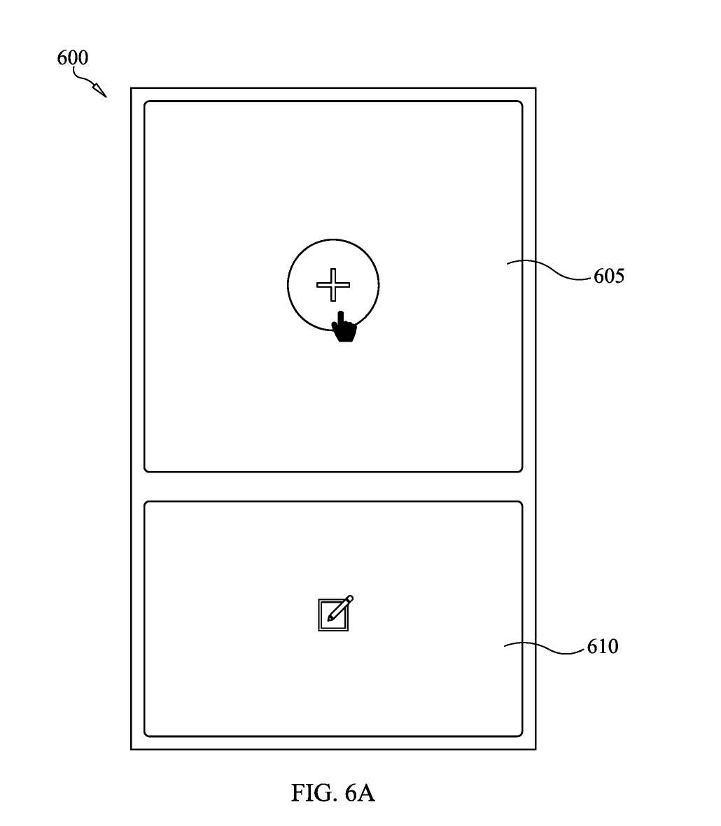

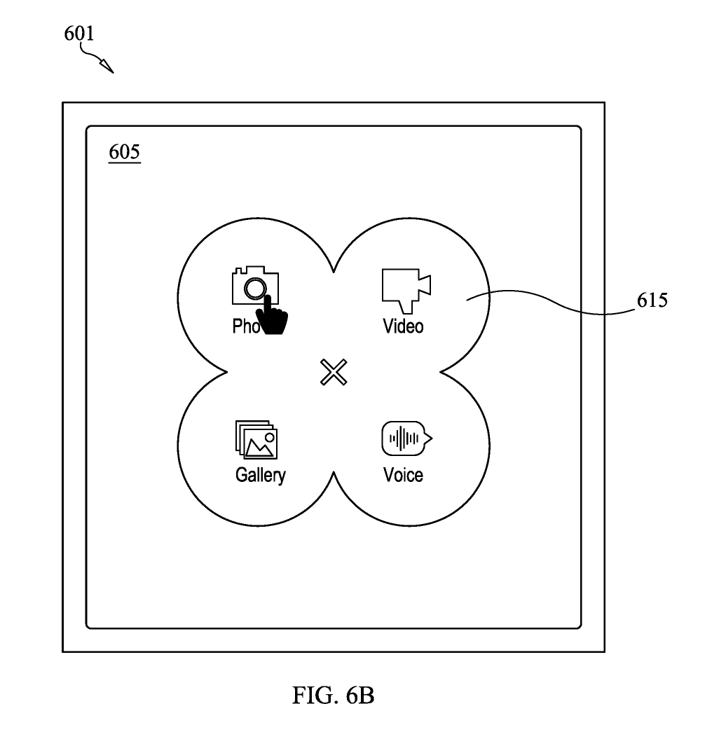

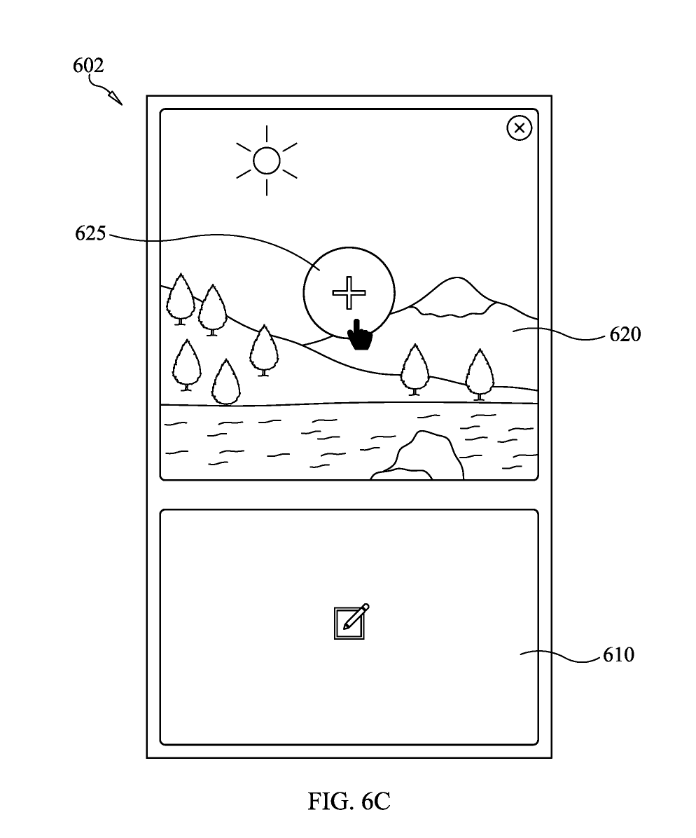

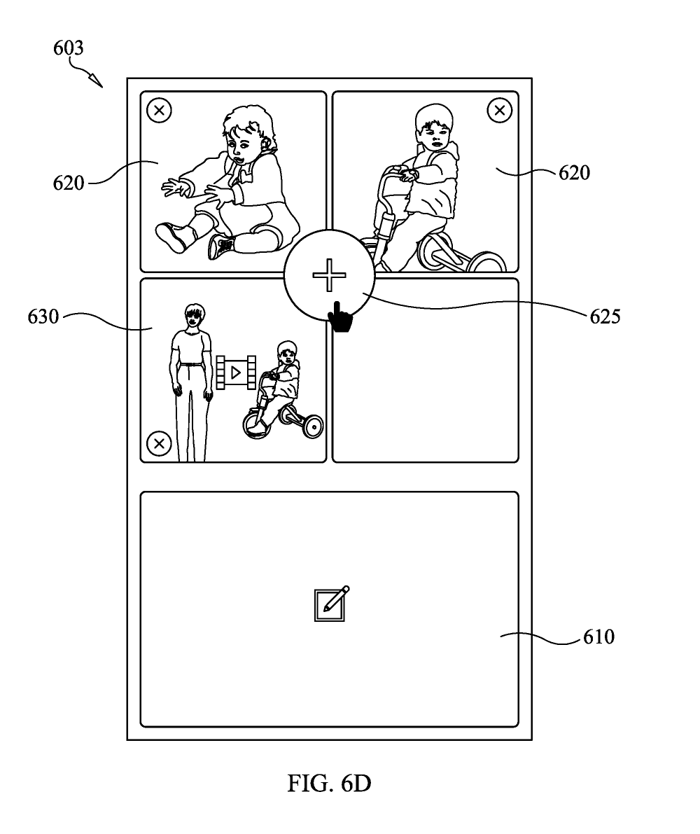

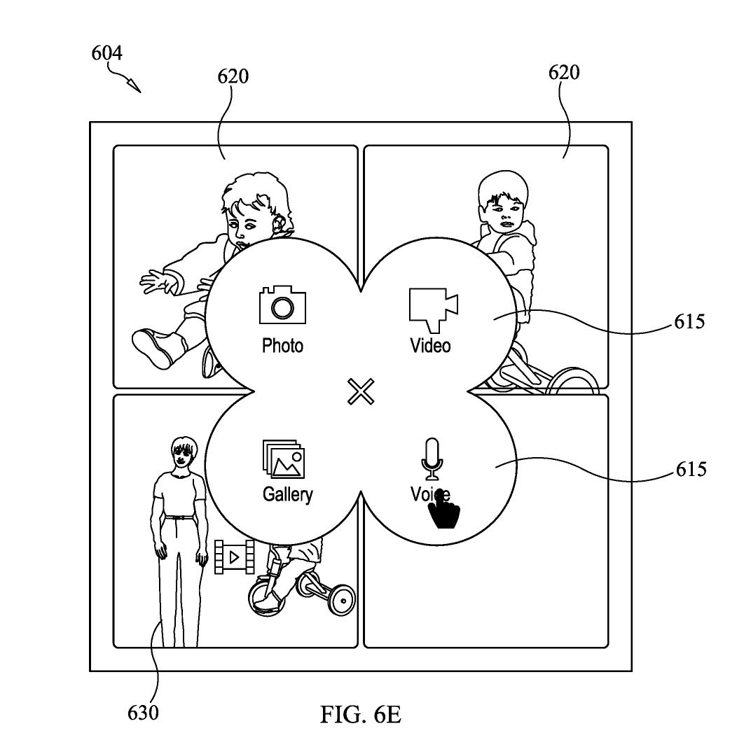

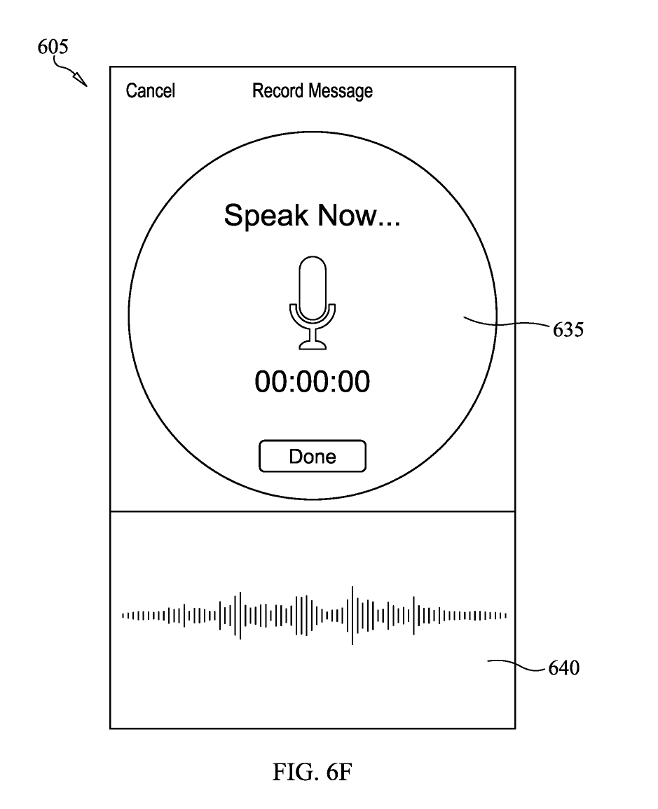

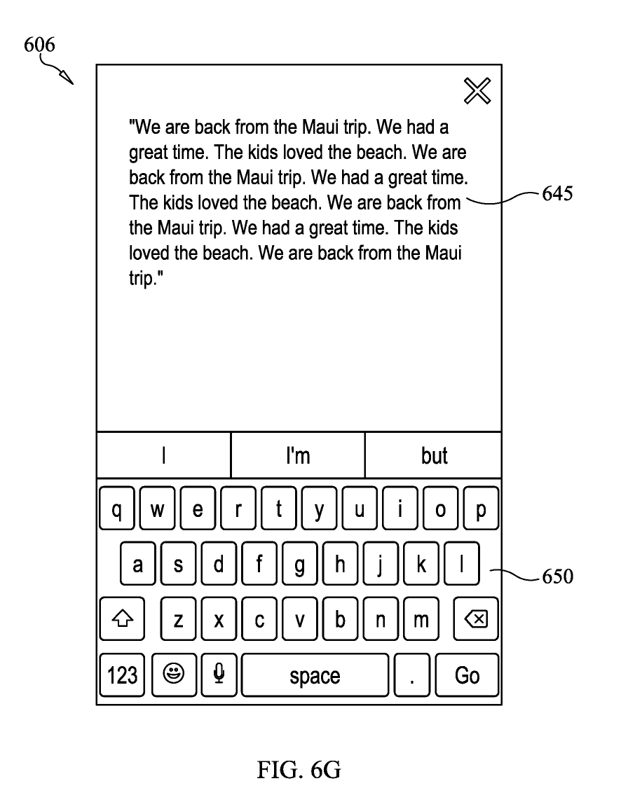

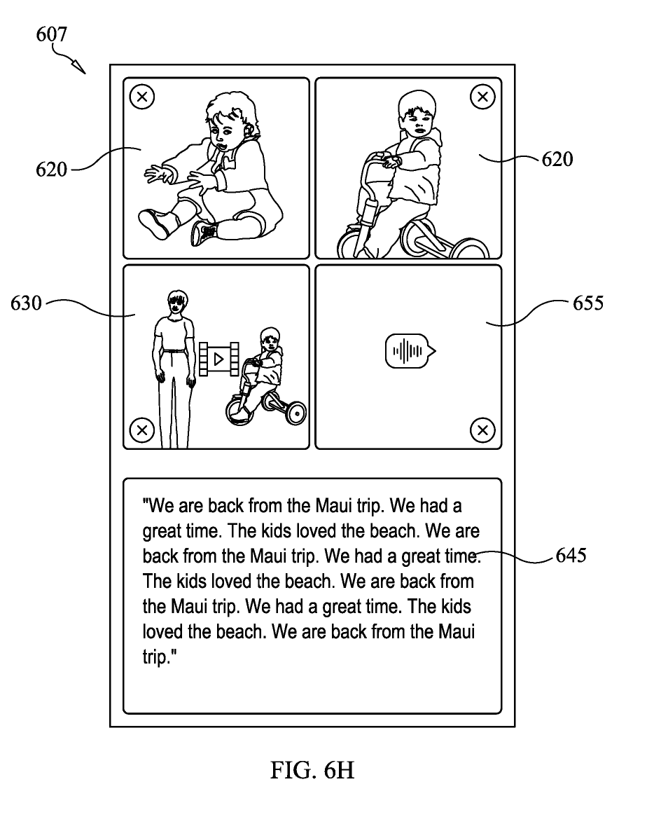

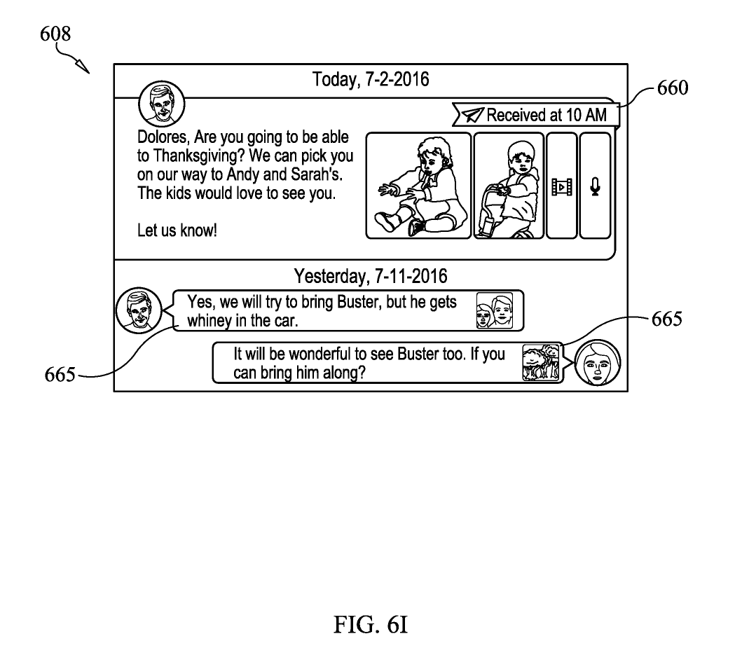

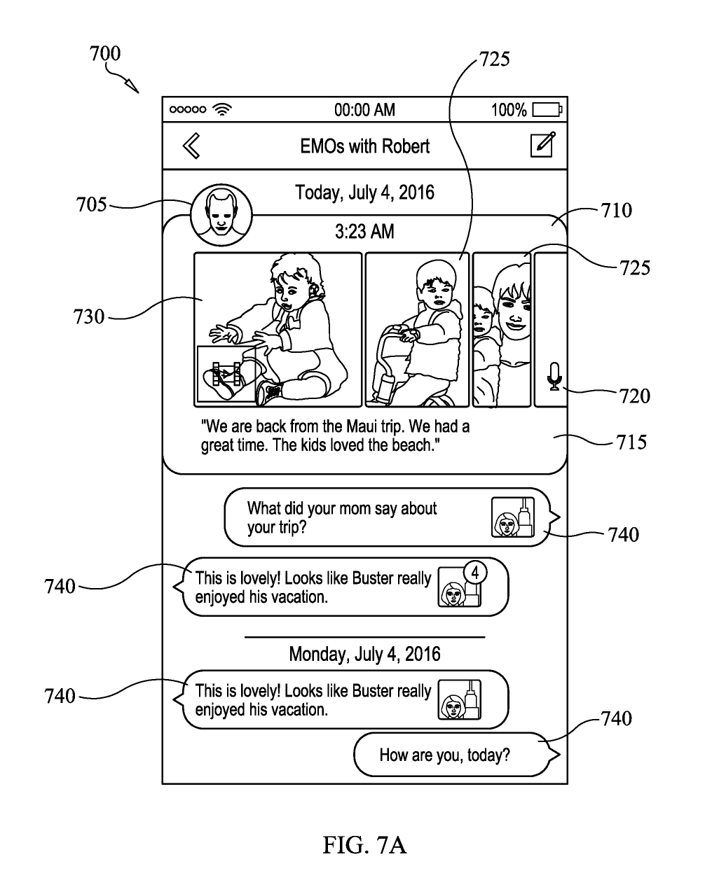

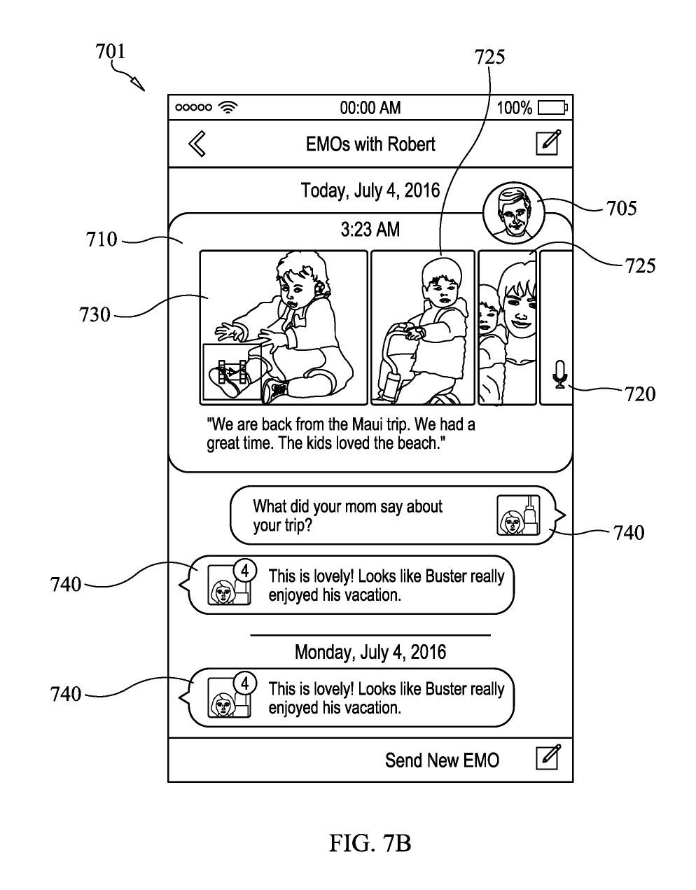

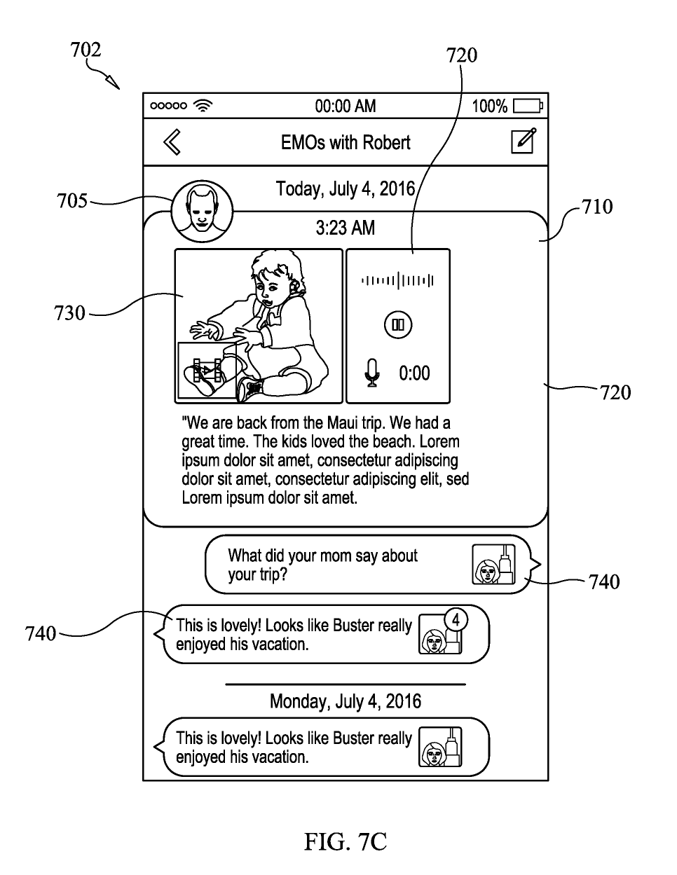

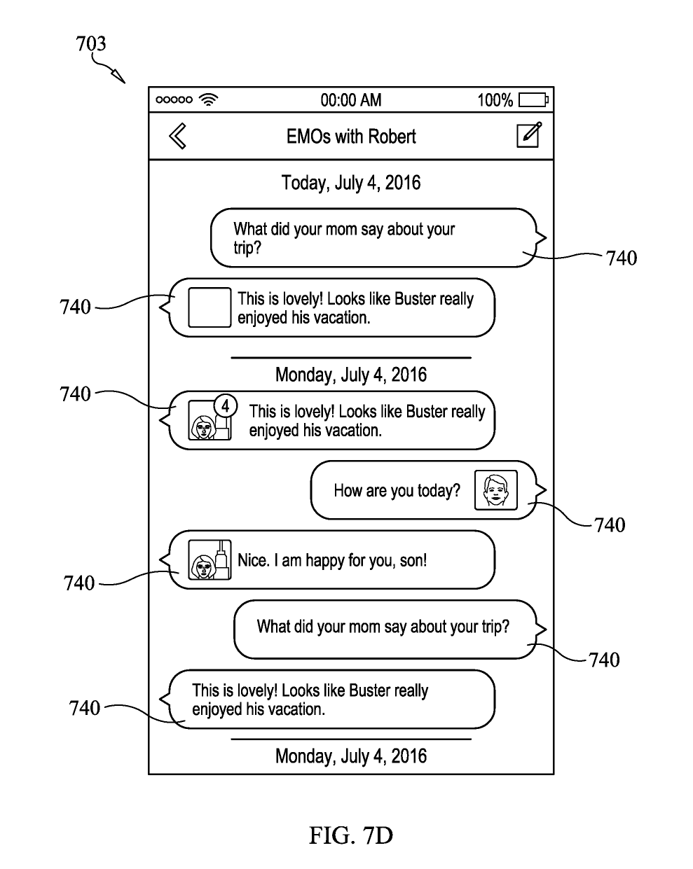

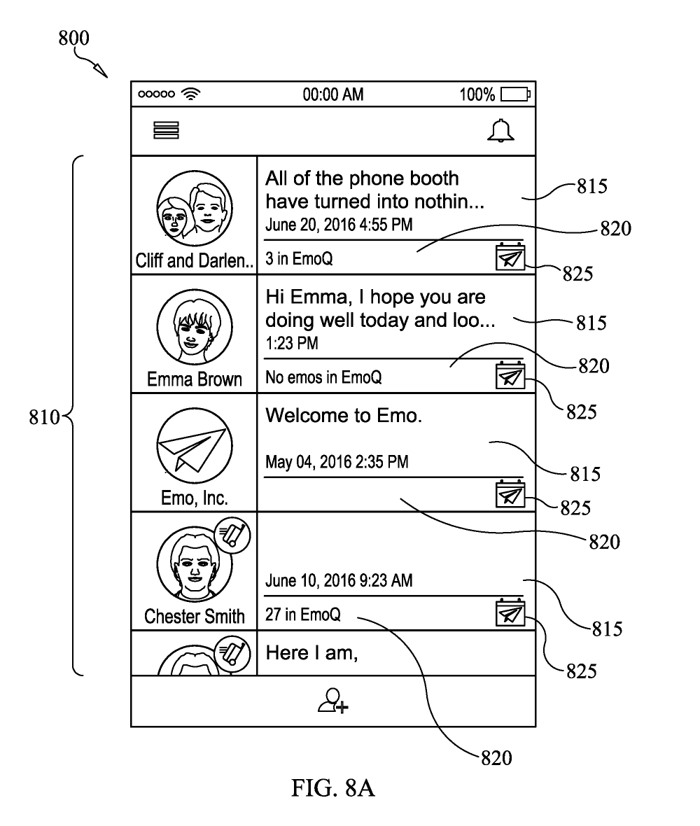

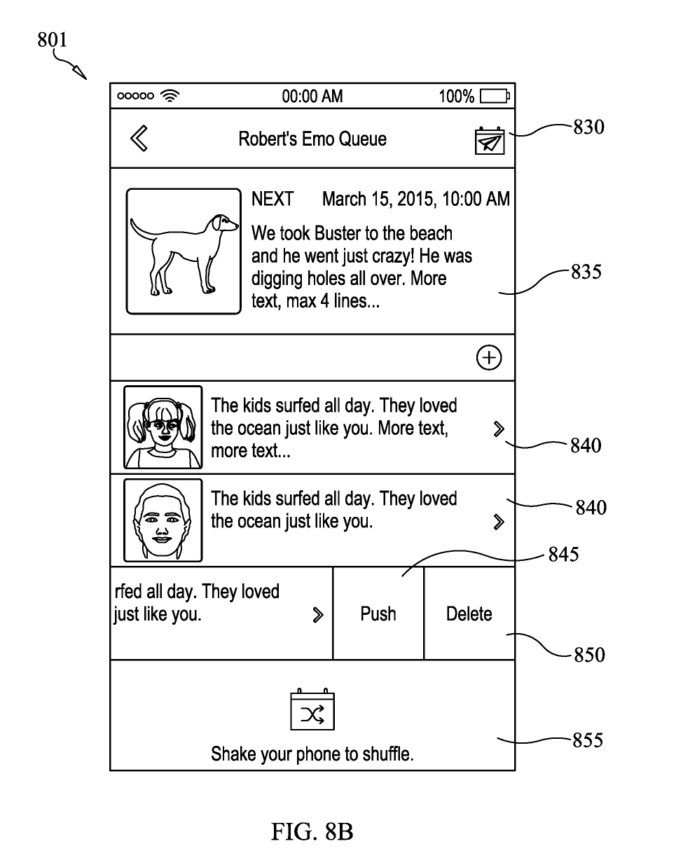

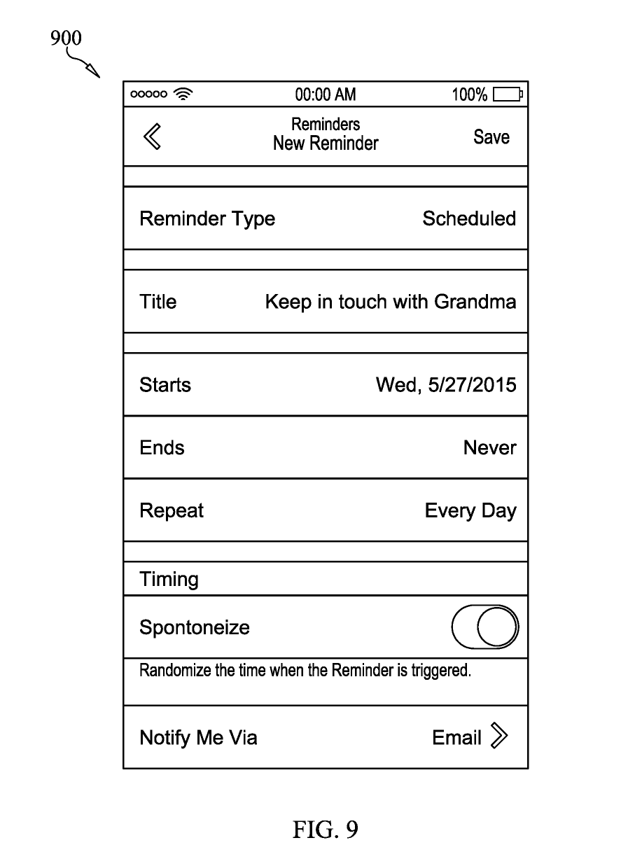

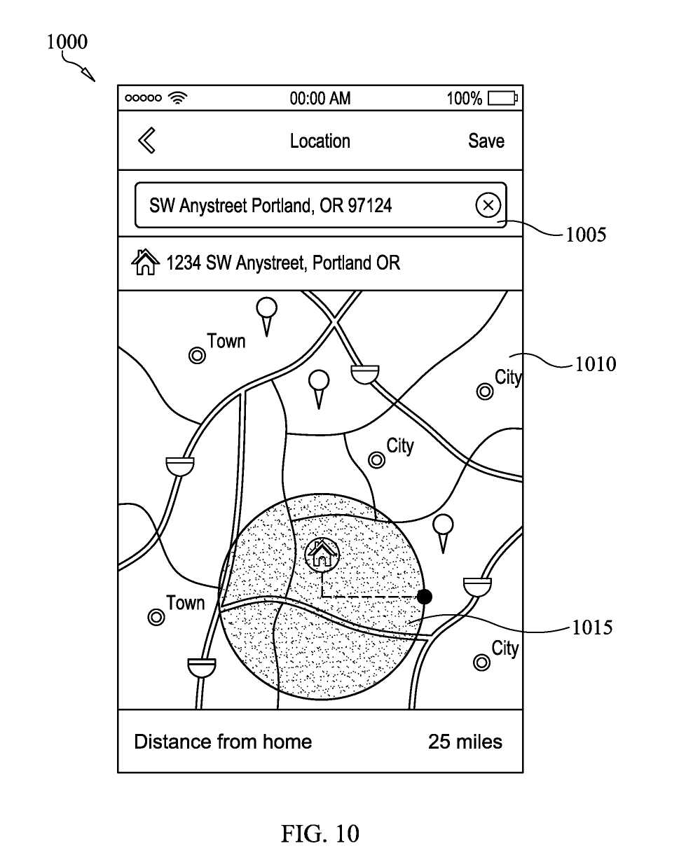

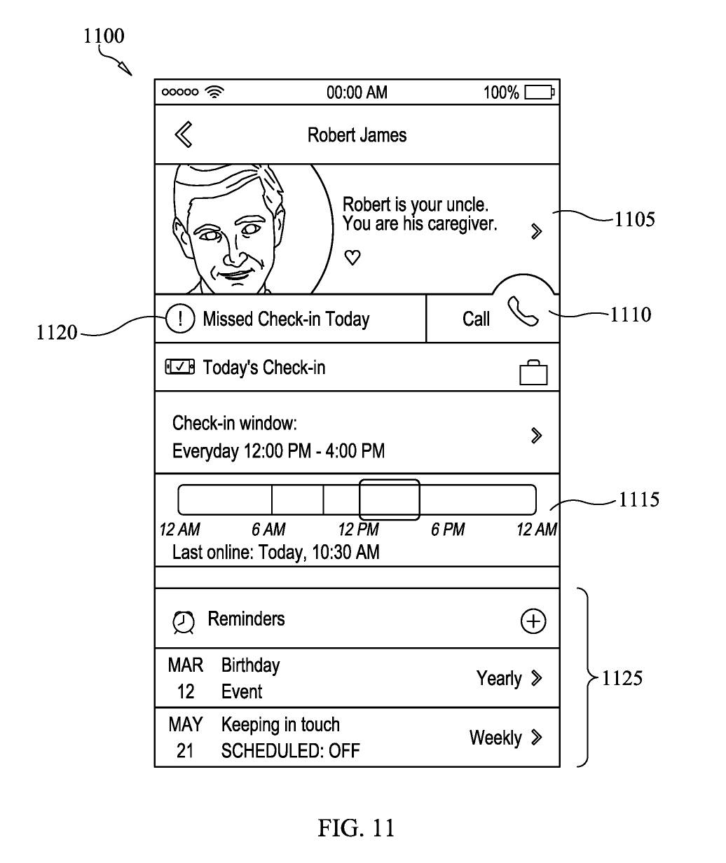

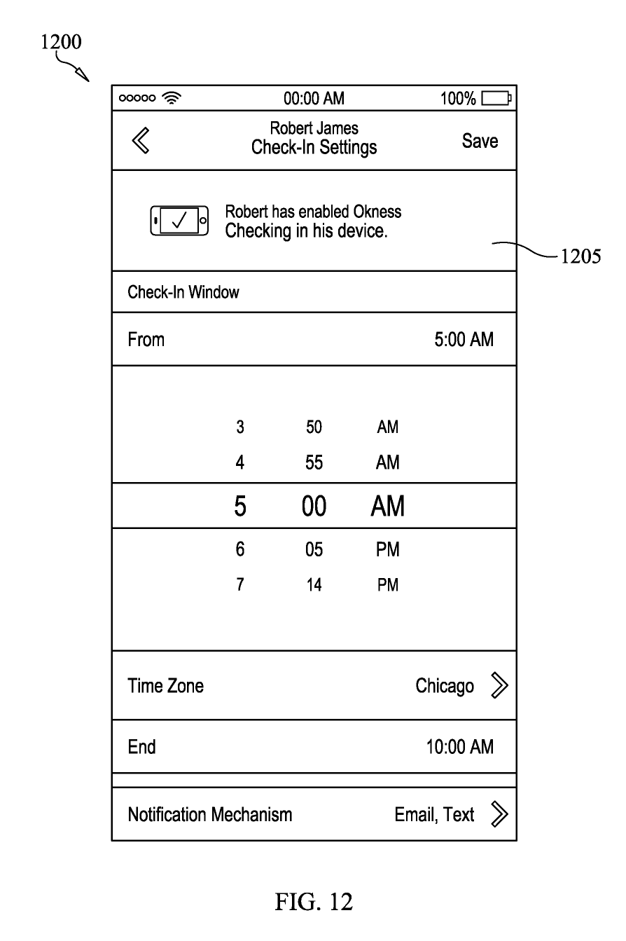

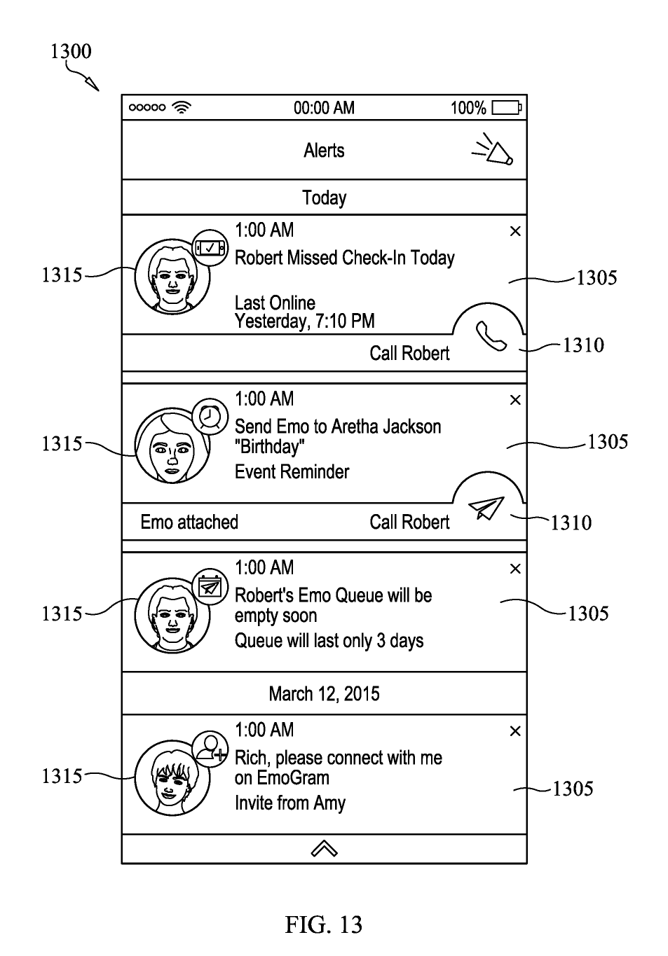

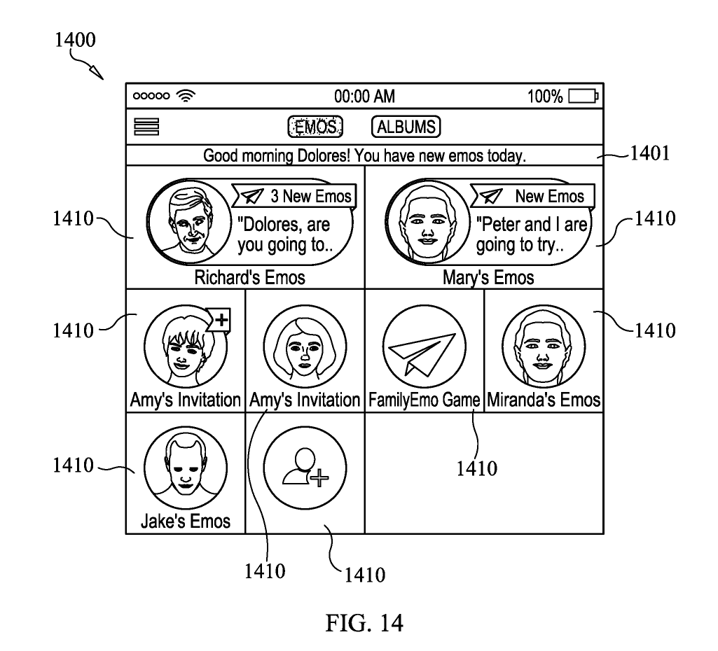

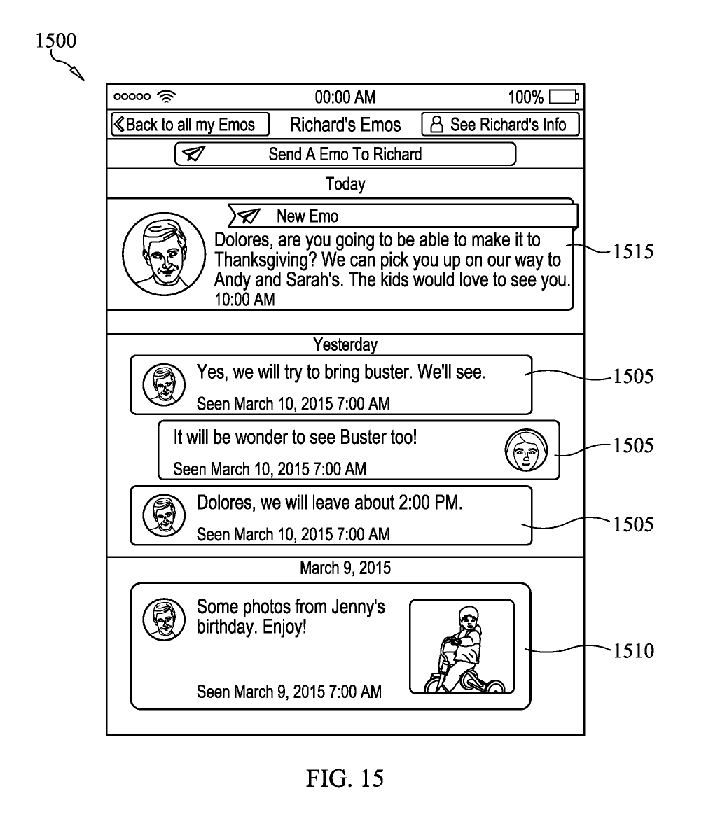

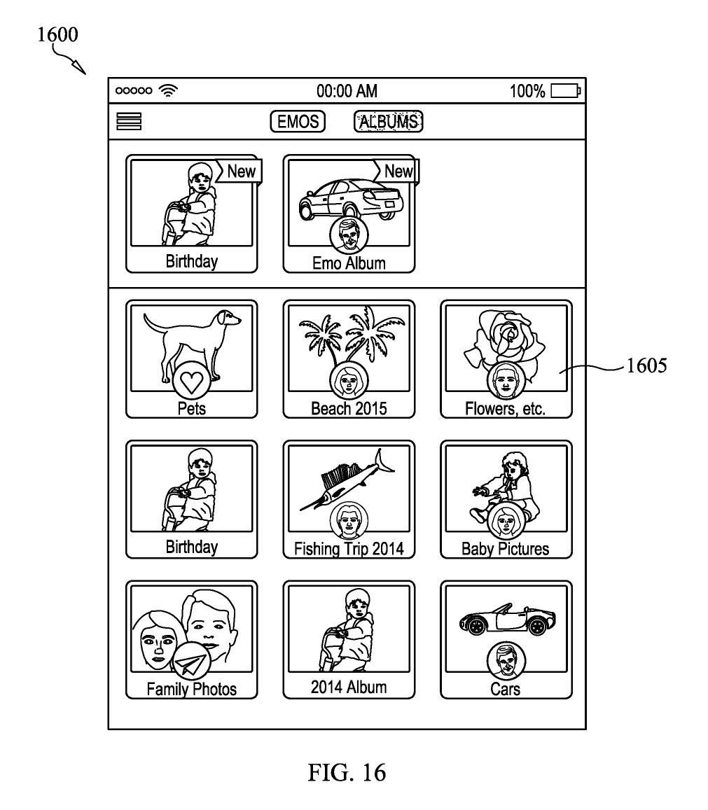

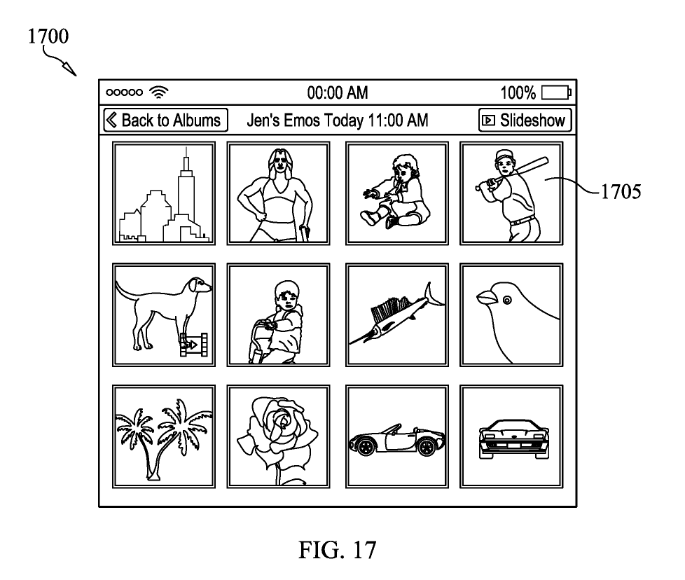

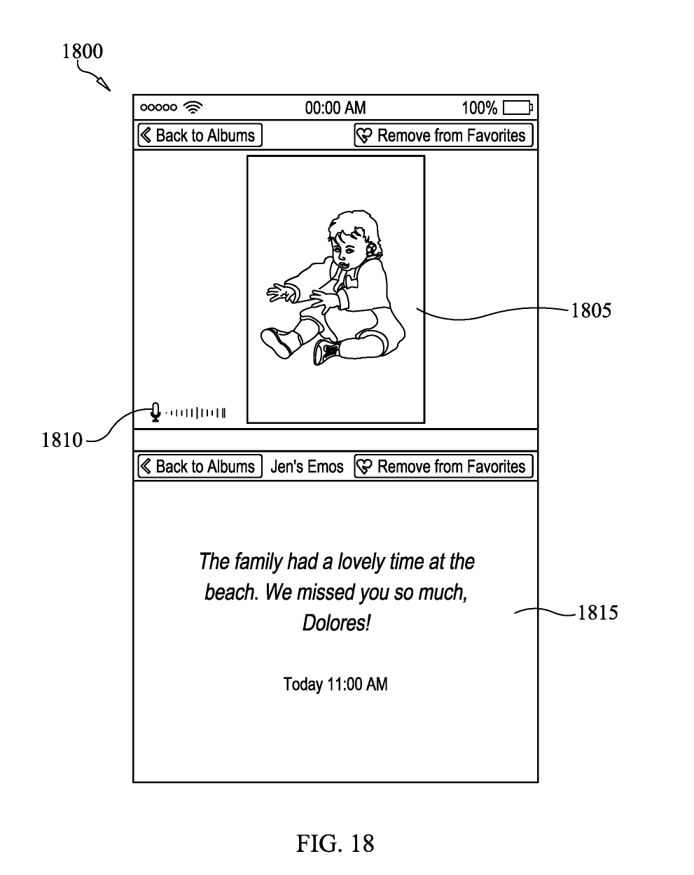

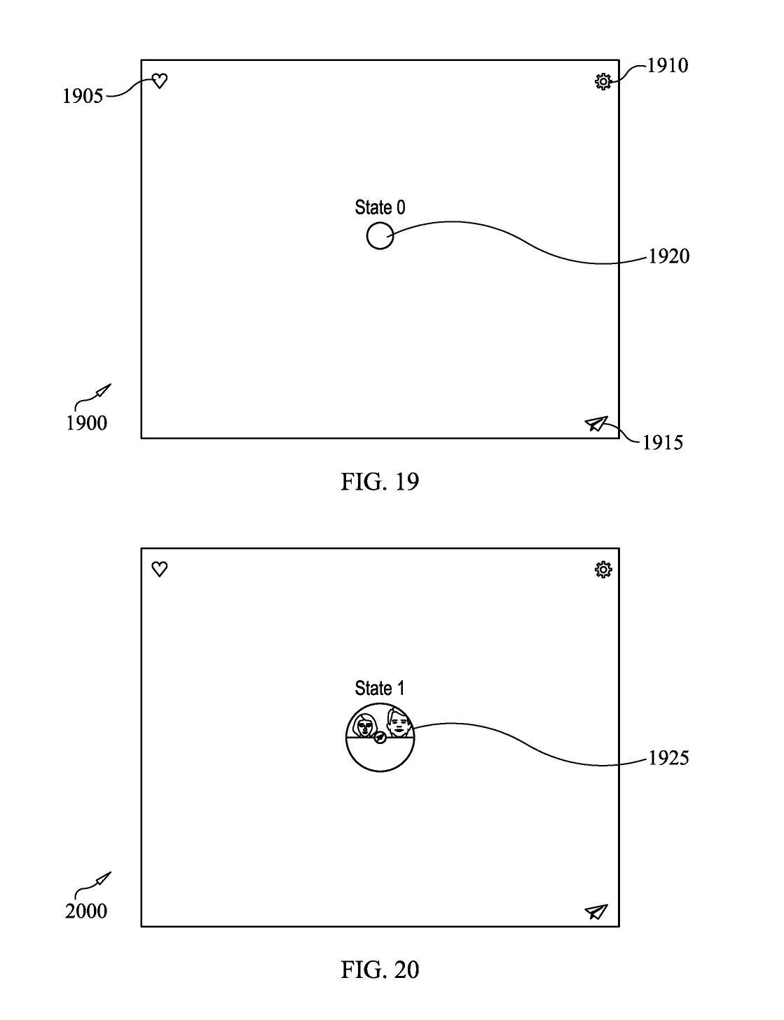

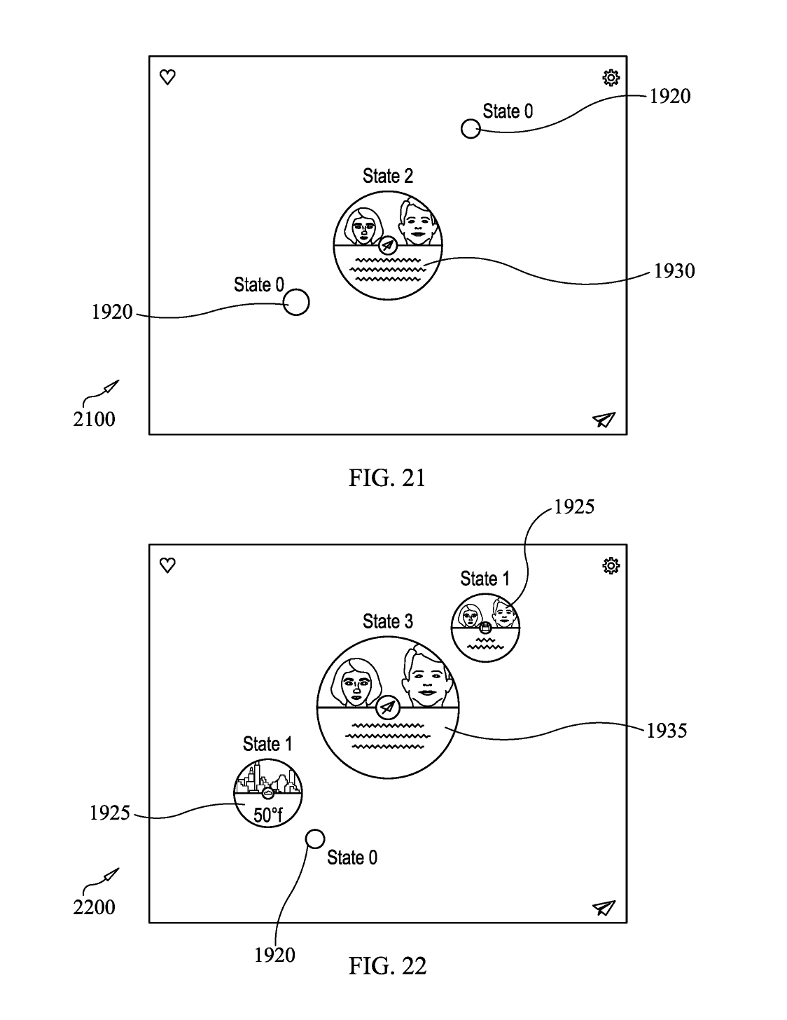

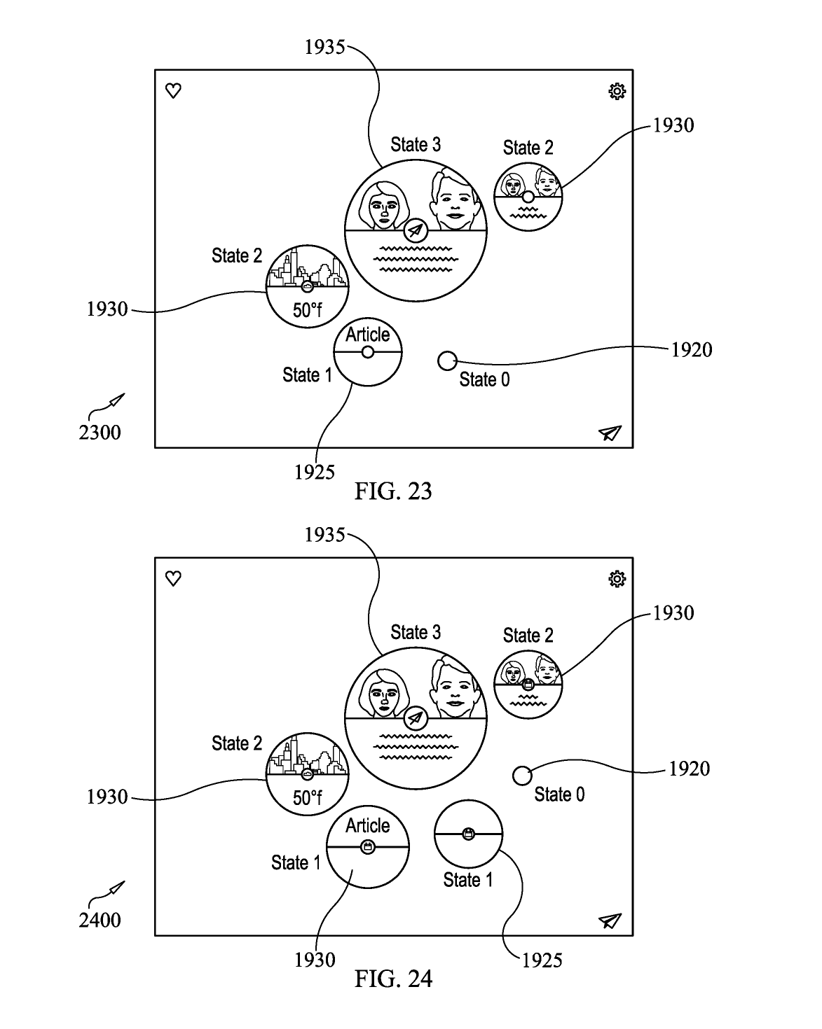

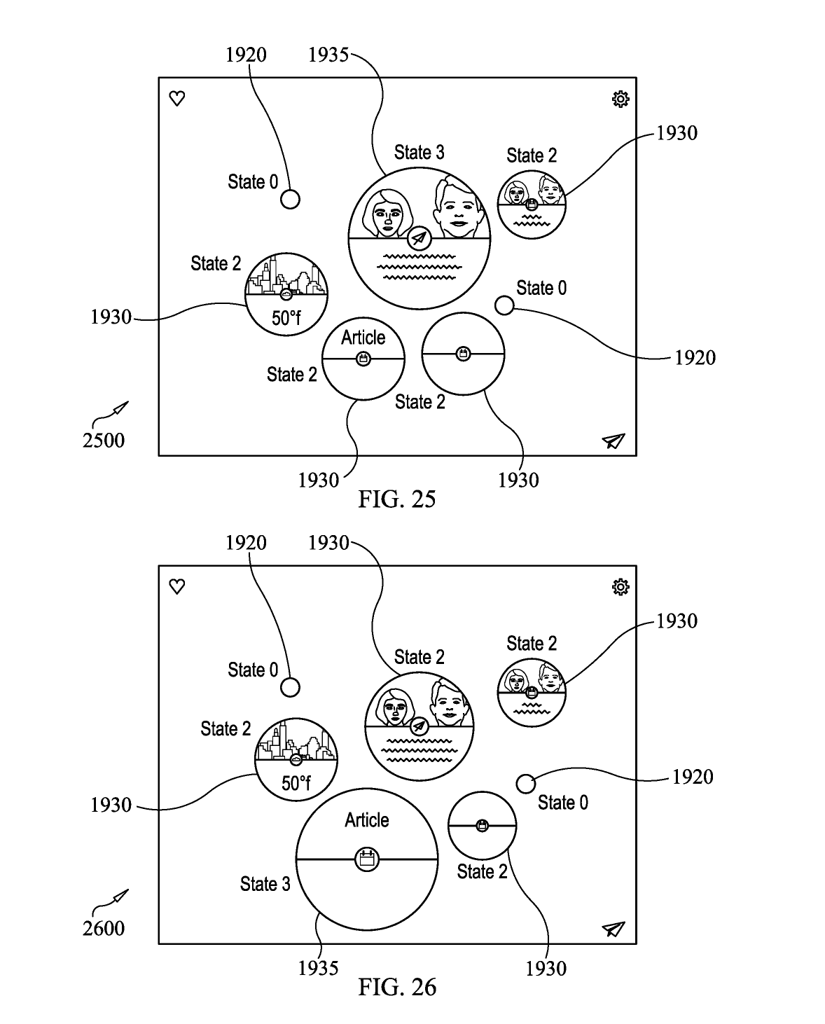

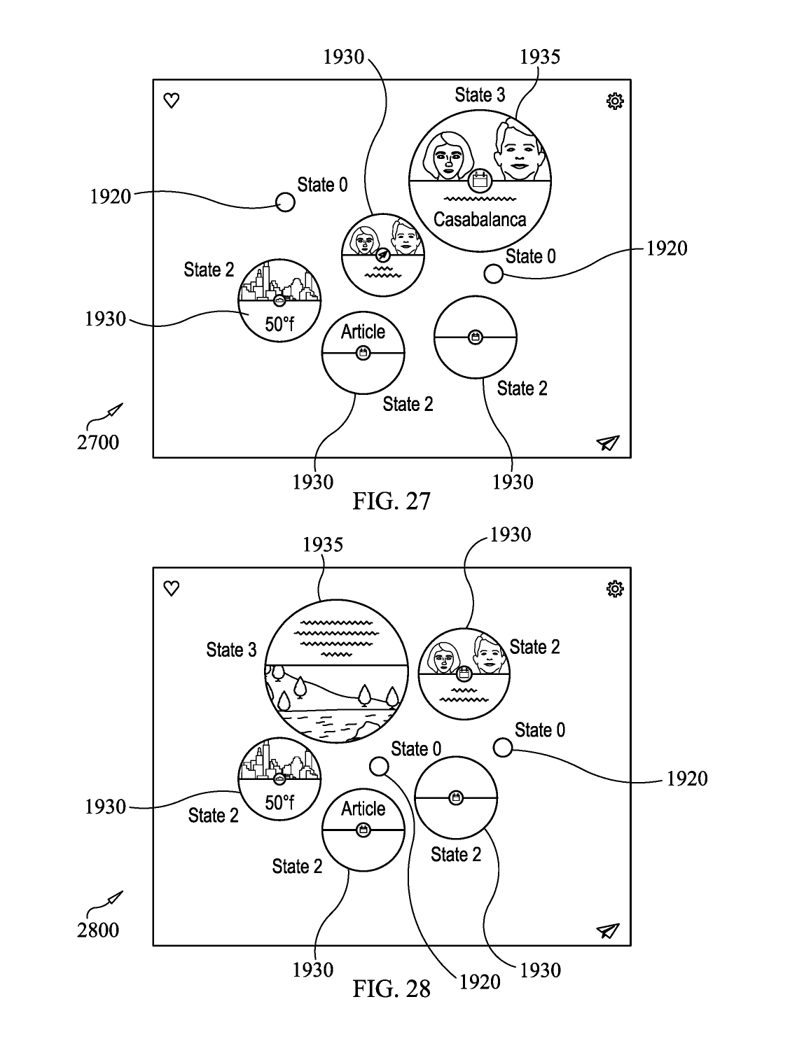

Exemplary EMO generation interfaces 600-607 for generating EMOs are provided in FIGS. 6A-6H, respectively. EMO generation interface 600 of FIG. 6A provides a multimedia entry/editing field 605 by which a user and/or recipient may enter and/or modify media (e.g., images, video, audio recordings) to be included in an EMO and a text entry/modification field 610 by which a user and/or recipient may enter and/or modify text to be included in an EMO.

EMO generation interface 601 of FIG. 6B shows a media-type-selection icon 615 provided in multimedia entry/editing field 605. Media-type-selection icon 615 provides a user with an option to select media types of photo, video, gallery, and voice although a person of skill in the art will understand that any number of media types may be accessed via media-type-selection icon 615. By selecting the photo portion of media-type-selection icon 615, a user and/or recipient generating an EMO may take and include a photo in an EMO.

FIG. 6C provides an EMO generation interface 602 that includes text entry/modification field 610 and a photograph 620 as well as an icon 625 that enables the user and/or recipient to add another photo to the EMO being generated. FIG. 6D provides an EMO generation interface 603 with text entry/modification field 610, two photographs 620, icon 625, and a video recording 630.

FIG. 6E provides an EMO generation interface 604 with two photographs 620, media-type-selection icon 615, and a video recording 630. When a user and/or recipient selects the voice portion of media-type-selection icon 615, an EMO generation interface 605 by which the user and/or recipient may record a voice or other audio recording may be provided as shown in FIG. 6F. For example, EMO generation interface 605 provides a start/stop recording icon 635 as well as a sound bar 640 that indicates when an audio signal or sound is being recorded.

FIG. 6G provides an EMO generation interface 606 with a text display window 645 and a text entry interface 650 a user may exit EMO generation interface 606 by, for example, selecting the icon (shown as an X) positioned in text display window 645. FIG. 6H provides an EMO generation interface 607 wherein the generated EMO includes two photographs 620, a video recording 630, an audio recording icon 655, and text display window 645. FIG. 6I provides a messaging interface 608 whereby the EMO 660 generated in interfaces 603-607 is sent and displayed in an expanded format. Messaging interface 608 also displays a plurality of EMOs shown in a minimized state 665. Display of EMOs in an expanded and minimized state will be discussed below with regard to FIGS. 7A-7D.

Optionally, recipient device 105 and user devices A-N 120 may be members of walled garden 125. Walled garden 125 may be a closed ecosystem or closed platform within which access to non-approved content and/or software applications may be restricted by, for example, one or more user devices A-N 120 and/or recipient device 110. In some embodiments, control of the walled garden may be exerted via one of the user devices A-N 120, which may be referred to herein as a primary or administrative user device A-N 120. Membership within walled garden 125 may be established via any appropriate means including, but not limited to, invitation and signing into the walled garden 125 using required credentials.

System 100 may include an optional sensor 150 that may be adapted to directly, or indirectly, observe the recipient 105 and/or the recipient's 110 behavior. Sensor 150 may be an individual sensor 150 or a combination of sensors 150. In some embodiments, sensor 150 may be a sensor that monitors a state of health (e.g., blood pressure, blood oxygen level, etc.) or motion of the recipient 105. In other embodiments, sensor 150 may be a Personal Emergency Response System (PERS) device (pendants recipient's carry with them at all times and can use to call for help by pressing a button on the device). In one embodiment, a sensor may be medication pillbox sensor configured to monitor when and whether a recipient has taken his or her medication. Sensor 150 may communicate the results to, for example, recipient device 110, one or more user devices A-N 120, computer system 130, and/or a third party 145.

Exemplary sensors 150 include a wearable device such as a smart watch, pedometer, force meter, medical alert device, an activity tracker, or motion sensor, and/or an external device, such as a blood pressure monitor, oxygen sensor, a thermometer, or home alarm system. In some embodiments, sensor 150 may be resident within recipient device 110 while, in other embodiments, sensor 150 may be resident recipient's 105 favorite chair, home, office, and/or car. In some instances, sensor 150 may be a situational sensor and/or an array of situational sensors, such as motion sensors placed throughout an environment inhabited by the recipient 105.

Sensor 150 may be adapted to observe and/or monitor one or more aspects of a recipient's 105 mental, emotional, or physical health. For example, an array of sensors 150 embodied as motion sensors may be used to determine how often the recipient 105 has moved from one room to another within a house. This information may then be communicated to one or more user devices 120 A-N and/or computer system, such as computer system 130 so that, for example, an inference about recipient's mental, emotional, or physical health may be made. For example, if motion sensors within a house provide an indication that recipient 105 did not leave his or her bedroom all day an inference may be made that recipient 105 is ill, too weak to get up, and/or depressed and one or more of users A-N 115A-N and/or response party 145 may intervene to check-in on recipient 105. In some instances, when sensors indicate a certain event (e.g., a fall, lack of responsiveness to a phone call, lack of movement within a house, etc.) a notification and/or alert may be sent to one or more user devices 120, response party 145, and/or computer system 130. In some embodiments, computer system 130 may be adapted to execute one or more actions or processes in response to the information received from sensor 150. Exemplary actions include communicating a notification to one or more user devices 120 A-N, recipient device 110, and/or response party 145.

In most instances, sensor 150 may report or otherwise communicate sensed data to computer system 130 for processing according to one or more instructions received from, for example, recipient device 110 and/or user devices A-N 120. However, in some circumstances, sensor 150 may be adapted to communicate directly with response party 145 when a particular type of event, typically one that may be classified as an emergency, occurs. Exemplary emergency-type events include detection of an unlawful entry into a resident of recipient 105, detection of a sudden movement of recipient 105 as may be consistent with a fall or other injury, detection of a message from the recipient 105, such as an activation of a medical alert device or a verbal command (e.g., “call the police,” or “call an ambulance”), etc. When an emergency-type event occurs, sensor 150 may also communicate an indication of the event directly to a user device A-N 120A-N and/or to computer system 130, which may, in turn, communicate the indication of the event to one or more user devices A-N 120A-N.

Computer system 130 may be one or more computer systems and/or computer components configured to execute one or more processes provided herein. In some embodiments, computer system 130 is one or more servers. Computer system 130 may be coupled to a data storage device 135. Data storage device 135 may, for example, store instructions, or sets of instructions to be executed by computer system 130 and/or another component of system 100. Data storage device 135 may also store data regarding the recipient 105, recipient device 110, user device A-N 120, sensor 150, and walled garden 125 for access by one or more components of system 100. Data storage device 135 may further store one or more data structures generated via execution of the processes described herein.

Communication between the components of the system 100 may be facilitated by communication network 140. Exemplary communication networks 140 include the Internet, a telecommunications service provider, a public switched telephone network, and a Wi-Fi network. In some embodiments, communication network 140 may be a combination of one or more providers of a wired and/or wireless communication signal by which communication between the components of the system 100 may be made.

In some embodiments, information may be retrieved by, for example, computer system 130 from a third party data source 150. Exemplary third party data sources include websites, news organizations, cloud computing companies associated with one or more users A-N 115A-N and/or recipient 105, and governmental agencies. In some instances, for example, when an emergency event occurs, computer system 130 may access information provided by third party data source 150 to retrieve information, such as a phone number for the police or a doctor.

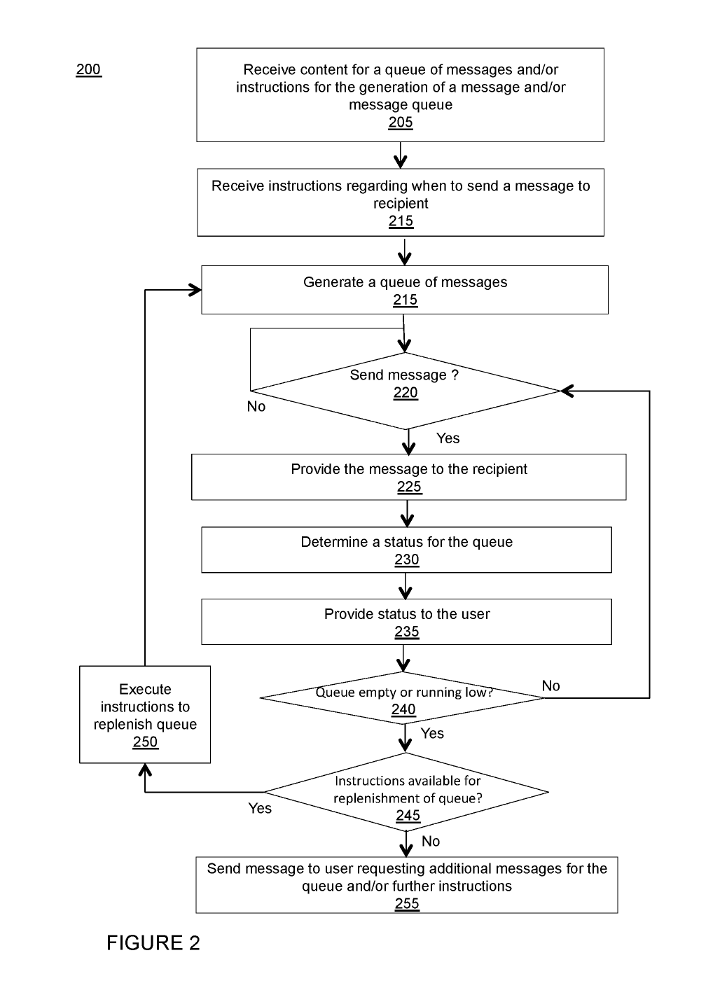

FIG. 2 is a flowchart that illustrates a process 200 for generating a data structure that includes a queue of messages and/or EMOs and providing one or more messages and/or EMOs in the queue to a recipient. Process 200 also provides for the spontaneous generation of messages responsively to received instructions. Process 200 may be executed by system 100 and/or any component included therein.

In step 205, content for a queue of messages and/or instructions for the generation of content to be included in a message and/or messages included in a queue may be received from a user, such as users A-N 115A-N via an interface provided by the user's user device, such as user devices A-N 120A-N. Various types of content may be received in step 205, including, but not limited to, pictures, text, and audio recordings. The content and/or instructions received in step 205 may be dependent upon one or more user and/or recipient preferences.

In some embodiments, the received instructions may require a computer system, such as computer system 130, to extract content from a third party content source, such as third party data source 150 to add to a message in a message queue and/or generated message. Additionally, or alternatively, instructions may be received to auto-generate content for inclusion within a message. For example, instructions may be received indicating that a message including a baseball score is to be sent to a recipient every time the recipient's favorite baseball team plays a baseball game.

In step 210, parameters and/or instructions for the communication of messages to a recipient may be received. Often times, these instructions will relate to when and how messages from the queue and/or generated messages to be provided to a recipient. The instructions received in step 210 may be highly customized and set up according to, for example, the preferences of a particular user and/or recipient. At times, the instructions received in step 210 may indicate that the communication of a message is to be dependent on occurrence of an event or time of day. For instance, an instruction to send a message saying “happy birthday” upon the annual anniversary of the recipient's birthday or an instruction to send a message saying “good morning” every day at 9 AM may be received. In one exemplary embodiment, the instructions received step 205 may require the content of a message to be “take your morning pills” and the instructions received step 210 may require the content of a message to be sent at 8:30 am every day.

In some embodiments, the instructions received in steps 205 and/or 210 may require utilization of a pre-configured set of rules for the generation and communication of messages that may, for example, mimic human behavior regarding the content and/or timing of the messages so as to appear to be sent directly from the user (as opposed to be partially, or wholly, sent/generated from a queue). The mimicry may be accomplished by using analytics to simulate human behavior when two people communicate with one another so as to, for example, make the communication a recipient and user feel more natural and spontaneous. For example, an instruction may be received in step 205 and/or 210 that a message from the queue is to be sent following expiration of a time period (e.g., 3 hours, 1 day, 3 days, a week, etc.) during which the user and recipient have not communicated. Such an instruction may avoid a situation in which a message is sent from the queue at an inappropriate time, which may indicate to the recipient that the message is auto-generated and thereby not a genuine attempt by the user to communicate with the recipient. In some instances, the instructions received in steps 205 and/or 210 may establish the use of a randomizer or artificial intelligence.

One exemplary option for the communication of messages to a recipient may incorporate sending the messages at spontaneously or randomly selected times. In some embodiments, the user may establish windows throughout, for example, a time span such as a day, week, month, etc. within which messages are to be spontaneously or randomly communicated. When messages are sent “spontaneously”, a base event may be selected (e.g., a day of the week or anniversary), and the timing for the communication of a message may be scheduled to occur randomly, or pseudo-randomly within a time frame (e.g., 2 days, one week, four hours) following or preceding occurrence of the base event occurs. In another example, the spontaneous timing for the communication of a message may be set to be plus or minus two days around a specific frequency of once a week.

Another exemplary option for a determination of content to be included in a message and the timing of the delivery of the message is based on a geo-location of the user and/or a relative distance between the user's device and the recipient's device. For example, a message may be automatically generated and sent to the recipient when the user is in a certain location or within a predetermined distance from a particular location. An example of such a message is “do you need anything from the store” when the user's device is within 15 miles of the recipient's device location. Another example is to send a message “I miss you” every day when the user's device is located more than 100 miles from the recipient's device.

FIG. 10 provides an exemplary message-triggering interface 1000 that may be displayed on a user device, such as user devices A-N 120A-120N and/or a recipient device such as recipient device 130 with a text entry box 1005, a map 1010, and a distance indicator 1015 superimposed on map 1010. In the embodiment of FIG. 10, a home icon is provided in the center of the map and distance indicator 1015 provides an indication of a 25-mile radial distance from the home icon. In some instances, a user and/or recipient may adjust the magnitude of the distance indicator 1015 by for example a touch or gestural input to a touch sensitive screen that provides interface 1000. Once set up, a distance indicator 1015 may act to trigger the transmission of a message or reminder to the user and/or recipient when he or she moves beyond the distance set up with the distance indicator 1015. In some instances, a user and/or recipient may set up a distance indicator to encompass a geographic area (e.g., residence, city, state, etc.) where he or she spends a substantial portion of his or her time and, when the user and/or recipient travels outside of the geographic area encompassed by the distance indicator, transmission of a message and/or reminder to the user and/or recipient may be triggered.

A further exemplary option for determining the content and/or timing of the delivery of messages is based on previously sent messages. In some cases, a message may be automatically generated and/or selected from a queue and sent to the recipient when communication between the recipient and the user has not occurred within a certain time period (e.g., four hours, two days, one week). This option may also be used to send notifications to the user reminding him or her to send a message to the recipient. In this way, feedback may be provided to the user when they forget to communicate with the recipient at a particular frequency of communication desired by the recipient and/or user.

An additional exemplary option for determining the content and/or timing of the delivery of a message is responsive to information received from a sensor associated with the recipient, such as sensor 150. At times, these messages may incorporate the information from the sensor or follow up/ask questions based on information received from the sensor. For example, when a sensor provides information that the recipient is asleep, then delivery of a message may be delayed until the sensor indicates that the recipient is awake. In another example, a sensor may indicate that the recipient has walked one mile and a message may be auto-generated and sent to the recipient in response to this information by saying “congratulations” or “keep it up.” In yet another example, when the sensor data indicates a relative lack of activity by the recipient, messages may be auto-generated and sent to encourage the recipient to move around or be social with a friend. Such auto-generated messages may include reminders to do things outside, or weather-based messages like “it's a beautiful day today” or “it's pretty hot today, but the temperature will be very comfortable for a walk outside after 4:30 pm.”

In another embodiment, a message may be auto-generated based on indicators of the recipient's social interactions within a given time period as reported by, for example, a sensor that indicates how often the recipient uses his or her phone or goes to a particular location associated with social activity. Messages from the queue may be selected and/or generated that encourage the recipient to engage socially with the user and/or someone else. Such a message may be “have you spoken with your nephew today?” or “would you like to go and play bingo today?”

In some instances, instructions to auto-generate messages may include instructions to access data from a third party, such as third party data source 150, for inclusion in the messages of the queue. For example, if the recipient is a soccer fan, an instruction to auto-generate a message indicating the score for each game of the season of the recipient's favorite team may be received. This instruction would require the server to access, typically via the Internet, a third party data store that includes the scores of the soccer games. Messages included in the queue may also be auto-generated using information from other third party sources, such as news websites or weather services.

Next, a message queue (hereinafter called a “queue”) may be generated responsively to the data received in steps 205 and 210 (step 215). The messages in the queue may be designed so that they appear indistinguishable from other messages sent by the user in a traditional (real time) manual manner when received by the recipient. FIG. 8A provides an exemplary interface 800 that provides information regarding a user's EMO queues. More particularly, interface 800 provides a recipient list 810 that provides an indication of recipients to whom the user communicates and/or sends EMOs to. For each recipient of recipient list 810, interface 800 provides an indication of an EMO last exchanged with respective recipient 815, an indication of how many EMOs are present in an EMO queue 820, and a icon 825, the selection of which may, for example, trigger presentation of a interface by which a user may edit and/or generate the user's EMO queue.

FIG. 8B provides an exemplary interface 801 that a user may use to generate and/or manage EMO queue for a particular recipient, in this case Robert. Interface 800 may include an indication of the recipient for the EMOs of the EMO queue 830, an EMO to be next delivered to the recipient 835, and as well as a number of EMOs scheduled for later delivery 840. Interface 801 may further include an icon 845 that facilitates pushing, or sending, a EMO in the EMO queue to an EMO queue set up for a different recipient in a manner similar to copying the EMO and pasting the copied EMO into the EMO queue set up for a different recipient. In this way, a user may select an icon 850 that facilitates the deletion of an EMO from the EMO queue, and an instruction window 855 that displays instructions for management of the EMO queue (in this case, an instruction to shake the user's device (i.e., phone) to shuffle the EMOs included in the EMO queue prior to communication to the recipient.

In step 220, it may be determined whether it is time to send a message from the queue and/or auto-generate a message. This determination may be made using the information received in steps 205 and 210. If no message is to be sent, then step 220 may repeat itself at some later time until a message is to be sent and process 200 advances to step 225, in which a message in the queue is provided to the recipient's device (step 225). The determination of step 220 may be done, for example, continuously, periodically, and/or upon occurrence of a condition (e.g., a powering on a device that stores and/or delivers messages from the queue).

Optionally, a status for the queue may be determined (step 230) and provided to the user (step 235). In some embodiments, determining the status may include keeping a running total of the number of messages remaining in the queue. The running total 605 of the message queue may be provided to the user via an interface, such as interfaces 600 and 601 as shown in FIGS. 6A and 6B, respectively discussed above. Additionally, or alternatively, execution of step 235 and 240 may include determining when a number of messages remaining in a queue falls below a threshold number. In these circumstances, a status indicator 610 for the queue may be provided to the user via interface 600. Examples of status indicators 610 for a queue include a warning regarding how many messages/EMOs are remaining in the queue and/or how long the queue is expected to last prior to running out.

In step 240, it may be determined whether the queue is empty, or running process 200 may return to step 220. When the queue is empty, or running low on messages, it may be determined whether instructions regarding the replenishment of the queue are available (step 245). In some circumstances, these instructions may be received in step 205. When instructions are available, these instructions may be executed to replenish the queue (step 250). Exemplary instructions may include an instruction to repeat one or more of the messages already delivered and/or an instruction to auto-generate more messages according to one or more user preferences using, for example, information provided by a third party data source such as third party data source 150. When no instructions for the replenishment of the queue are available, then a message may be sent to the recipient requesting further instructions and/or additional messages to be included in the replenished queue (step 255).

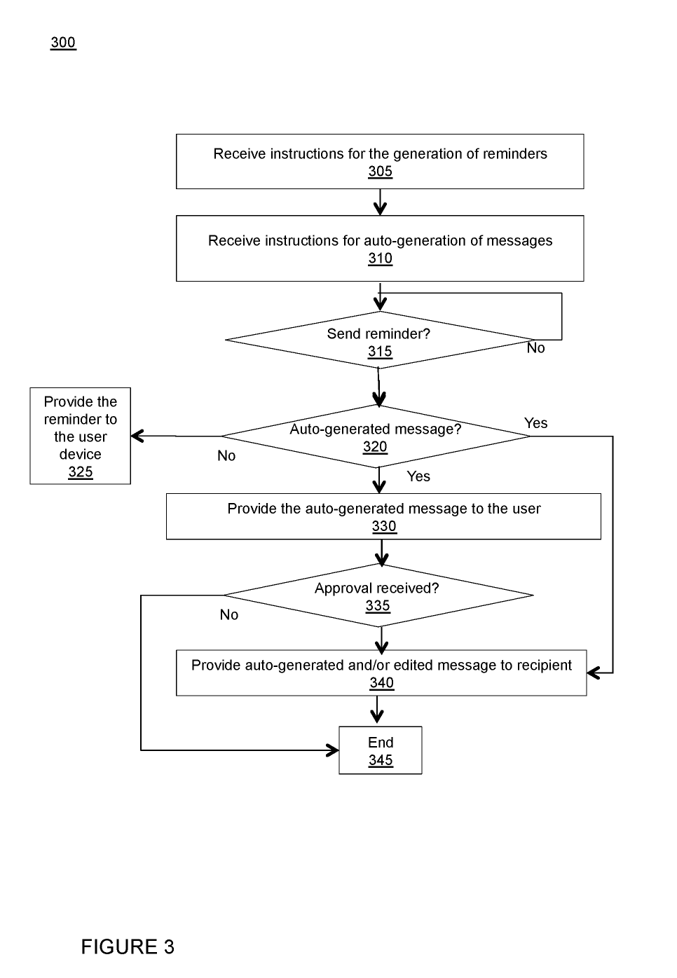

FIG. 3 is a flowchart that illustrates a process 300 for providing one or more reminders and/or pre-configured messages to a user, such as users A-N 115A-115N via a user device, such as user devices A-N 120A-120N. The reminders may serve to remind the user to communicate, or otherwise interact, with a recipient, such as recipient 105 via, for example, messages sent to a recipient's device, such as recipient device 110. The reminders may serve to trigger a communication between the user and the recipient. The communication may be, for example, a message, phone call, email, etc. Many of the steps of process 300 have characteristics in common with process 200, as described above. Process 300 may be executed by system 100 and/or any component included therein.

In step 305, instructions for the generation of one or more reminders to communicate with the recipient may be received at, for example, computer system 130 by way of the user's communication with an interface, such as interface 900 as will be discussed below with regard to FIG. 9, provided by his or her user device. The instructions received may be similar to those received in step 205, with the exception that they are directed to the generation of reminders instead of a message queue. More specifically, the options for the generation and communication of messages in message queue described above may be adapted for use within process 300. The received instructions may relate to, for example, how, when, and why to send reminders to a particular user device or group of user devices. In some instances, a group of users may be users within a walled garden, like walled garden 125 or user devices and/or user accounts associated with one or more user devices that may be, for example, on a reminder mailing list. The received instructions may further relate to the content of the reminder. At times, the reminder's content may be as simple as an audio alarm and, at other times, the reminder's content may be a preconfigured message that is ready to send to the recipient upon approval by the user.

In step 310, instructions for the auto-generation of messages may be received. These instructions may relate to, for example, how, when, and why to auto-generate a message as well as provide for content of the message. In some instances, some, or all, of the content of the auto-generated message may be sourced from a third party, such as a third party website or news stream.

In some instances, a reminder, a set of reminders, a message, and/or a set of messages may be generated and stored in a data structure responsively to steps 205 and 210. In other instances, the instructions may be used to trigger the contemporaneous generation of a reminder and or/auto-generated message at an appropriate time.

In some embodiments, instructions for the generation of reminders and/or auto-generation of messages may be received via a new reminder interface 900 as shown in FIG. 9. Using interface 900, a user may determine the type of reminder/auto-generated message (e.g., scheduled, random, triggered by a specified event, as needed, etc.) to be provided. Exemplary specific events that may trigger a reminder/auto-generated message include a weather event, a news event, an event that occurs within a family (e.g., birth of a child or marriage). The user may set up and/or modify a reminder/auto-generated message by, for example, specifying a title, start date, start time, end date, frequency of repetition, etc. for the reminder/auto-generated message. In some embodiments, a user may establish timing for the triggering/communicating of reminders to the user device, such as random timing, spontaneous timing, a time of day, week, month, etc. The user may also specify a preferred manner in which to receive the reminder/auto-generated message (e.g., email, SMS text message, audio alarm, etc.).

In step 315, it may be determined whether a reminder generated responsively to the instructions of steps 205 and/or 210 should be sent to the user device (step 315) and, if not, step 315 may repeat itself at, for example, periodic or random intervals until a reminder should be provided to the user device. When a reminder should be sent, it may be determined whether the reminder should include an auto-generated message (step 320). When the reminder does not include an auto-generated message, then the reminder may be provided to the user device (step 325). When a reminder does include an auto-generated message, the auto-generated message may be provided to the recipient (step 340). Additionally, or alternatively, the auto-generated message may be provided to the user device (step 330) so that the user may approve the auto-generated message (step 335) when a reminder includes an auto-generated message. In some instances, the auto-generated message may be a template into which the user inserts his or her content. At times, the approval process of step 335 may include, for example, editing the pre-generated message and/or providing content (e.g., a picture or text) for the message. In some instances, instructions for approving an auto-generated message automatically may be received in, for example, step 310. Sometimes the instructions to automatically approve an auto-generated message may indicate that an auto-generated message is approved upon expiration of a time period (e.g., 5 or 15 minutes) unless the user explicitly instructs not to send the auto-generated message. Upon receipt of approval the auto-generated and/or modified message may be provided to the recipient device (step 340). When the message is not approved, it may remain open for the user to eventually approve and/or process 300 may end (step 345).

It is often difficult to determine the physical, mental, and/or emotional health of a family member or individual of concern from a distance. For example, when a user, such as one or more users A-N 115A-N and a recipient such as recipient 105 are geographically separated, it may be difficult for the user, to determine the status of the recipient. when they are not in the same building, city, or state.

Traditional methods of reliably checking in on a recipient are cumbersome, unreliable, and impractical especially when the recipient is emotionally, mentally, and/or cognitively impaired. In many cases, checking in on a recipient requires cooperation on the part of a recipient, which may be difficult to obtain especially when the recipient resistant to attempts to check in, as may be the case when, for example, a parent perceives they are being treated like a child. Another conventionally available method of checking in on a recipient requires the user initiating a phone call with the recipient. However, this method is problematic because recipient may not always answer a phone for a host of reasons that are not indicators of a problem (e.g., being outside when the phone rings or being on the phone with someone else). Furthermore, this method requires the user to remember to call the recipient and, at times may require the recipient becoming involved in a phone call with the recipient at a time that is inconvenient for him or her. Also, in situations where the user wishes to intermittently check in with a recipient over the course of a day, multiple phone calls to the recipient may be seen as more of an annoyance to the user and/or recipient than an act of kindness.

Another traditionally available method of monitoring a recipient, or at least determining when something bad has happened to a recipient, is use of a PERS device. However, these devices are often met with resistance from recipients because of a perceived stigma attached to using them and the fact that recipients do not always consistently use the devices because they forget to wear them or leave them off for extended periods of time.

Described herein is an exemplary process, or check-in protocol for monitoring a health and wellness state of a recipient that overcomes these obstacles by encouraging a recipient to use a recipient device within defined time period and notifying a user when the recipient has failed to do so. The user, upon receiving the notification, may then follow up with the recipient to check-in on recipient or otherwise determine a status of the recipient.

In many cases, the recipient's interaction with the recipient device is designed to integrate into the recipient's daily activities so the recipient is more likely to participate with a check-in protocol and find value in participating. Where appropriate, the check-in protocol may be designed so as to not appear to be an attempt to assess the recipient's status. In this way, the recipient's status may be indirectly monitored without, in some instances, use of specific health or well being questions or assessments.

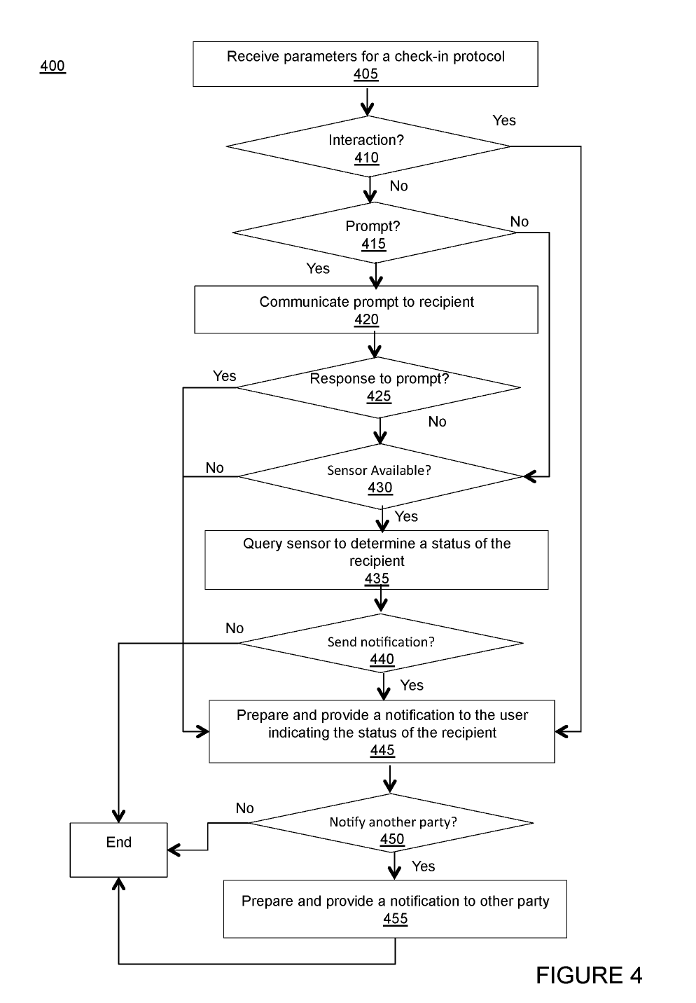

FIG. 4 provides a flowchart of an exemplary process 400 for monitoring a health and wellness state of an individual, which may be referred to herein as a “check-in protocol.” In some embodiments, process 400 provides for the creation and execution of a recipient check-in protocol. Process 400 may be executed by, for example, system 100 and/or a component or combination of components included therein.

Initially, in step 405, one or more parameters for a recipient check-in protocol may be received. The parameters may be received by, for example a computer system such as computer system 130 from a user device, such as user device A-N 120A-120N via a communication network, such as communication network 140. The parameters may establish a time, or times, of day (e.g., 9 am, 12:30 pm, 5 pm, etc.) when a recipient is expected to interact with a recipient device, such as recipient device 110. The parameters may also establish one or more time period durations (e.g., 8 am-10 am, 12:30 pm-1 pm, 11 am-4 pm, etc.), which may also be referred to herein as “check-in windows,” during which the recipient is expected to interact with the recipient device.

In some embodiments, the check-in times and/or check-in windows may vary according to a schedule that may, or may not, be specific to, for example, an individual recipient and/or a calendar. For example, a schedule that may apply to check-in times and/or check-in windows may be based upon, for example, an annual calendar, an activities calendar for a facility in which the recipient lives, a holiday season, or special event. In this way, the check-in times and/or check-in windows may be easily adapted to accommodate the individual schedule or activities of the recipient.

Parameters received for a check-in protocol may also relate to a preference for how the check-in is to be executed. For example, in some circumstances, the recipient may be expected to use his or her recipient device within the check-in times and/or check-in windows without prompting and, in other circumstances, the recipient may need prompting to interact with the recipient device during check-in times and/or check-in windows and the parameters received in step 405 may accommodate these expectations. Parameters for a prompt may include a format or type of prompt. Exemplary prompts include, but are not limited to, a message, a picture, a trivia question, a drawing to color in, unlocking a video game, music, a photograph, a puzzle, a trivia fact, or some combination thereof. The parameters for a prompt may also include when a prompt is to be delivered and an appropriate response by the recipient to the prompt. In some embodiments, the recipient's response may be analyzed to determine if it is a correct and/or appropriate response to the prompt and, in this way, the of health and/or wellness may be assessed by, for example, a computer system such as computer system 130 and/or a user who receives a notification indicating the recipient's response to the prompt on his or her user device. In one example, a prompt such as “how are you?” may be provided and the recipient's response may be analyzed to determine the recipient's status. In another example, a prompt may be a question known to test neurological function directly and/or indirectly. Such prompts may be, for example, a math problem, a trivia question, or a visual puzzle.

On some occasions, parameters may be received in step 405 via an interface like interface 1200 as shown in FIG. 12. Interface 1200 may be used to establish a check-in window, which may provide a user with an opportunity to select a time of day, a window of time (i.e., with a start and end time), and a time zone. Interface 1200 may also provide an indication 1205 of whether a recipient has opted in or otherwise enabled participation with a check-in protocol.

Once the parameters are received in step 405, the recipient check-in protocol may be created therefrom. In step 410, it may determined whether the recipient has used, or otherwise interacted with, the recipient device and/or a software application running on the recipient device within the check-in times and/or check-in windows (step 410). In some instances, execution of step 410 may include communication between, for example, the computer system and the recipient device by way of exchanged messages. In one embodiment, the recipient device may notify the computer system when the recipient interacts with the recipient device. Additionally, or alternatively, the computer system may query the recipient device to determine whether the recipient has used, or otherwise interacted with, the recipient device within a particular check-in time and/or check-in window.

When the recipient has used, or otherwise interacted with, the recipient device within a check-in time and/or check-in window, then process 400 may proceed to step 440 and a notification to the user indicating the recipient's interaction with the recipient device and/or status may be prepared and provided to the user. The notification of step 440 may be provided by any appropriate means including, but not limited to, a SMS text message, an email, and a phone call. In some embodiments, the means by which the user is to be notified may be established in the parameters received in step 405.

When the recipient has not used, or otherwise interacted with, the recipient device within the check-in times and/or check-in windows, then it may be determined whether the recipient should receive a prompt based on, for example, the parameters received in step 405 (step 420). When a prompt is to be sent, the prompt may be prepared and communicated, in accordance with, for example, the parameters received in step 405, to the recipient device and it may be determined whether a response to the prompt is received (step 425). When a response to the prompt is received, process 400 may proceed to step 440.

When a prompt is not to be sent, and/or a response to the prompt is not received, process 400 may proceed to step 430 and a determination of whether a sensor, such as sensor 150, is available may be made. When no sensor is available, process 400 may proceed to step 440. When a sensor is available, the sensor may be queried to determine a status of the recipient (step 435). Next, a determination as to whether or not to send a notification indicating the recipient's status to the user may be made (step 440) based on, for example, the parameters received in step 405. In some instances, a notification may be sent only when the recipient's status is negative (i.e., hasn't interacted with recipient device and/or a software application running on the recipient device) and, on other occasions, a notification is always sent. When no notification is to be sent, process 400 may end. When a notification indicating the recipient's status is to be sent, it may be prepared and provided to the user (step 445).

In some embodiments, the notification of a recipient's status may be provided to a user via an interface like check-in interface 1100 provided by FIG. 11. Check-in interface 1100 provides an indicator 1105 of the recipient being checked on. Indicator 1105 may provide information regarding who the recipient is (e.g., name or location) and the nature of the user's relationship with the recipient (in interface 1100, the relationship is caregiver). Interface 1100 provides a message 1120 to the user indicating whether the recipient has checked in during a particular time interval. Check-in interface 1100 also provides a mechanism 1110 (in this case a “call” icon) by which the user may seamlessly contact the recipient via, for example, a message or phone call. In some instances, mechanism 1110 may facilitate activation or communication with one or more sensors that may be employed to monitor the recipient. For example, mechanism 1110 may be used to communicate with a camera or motion sensor positioned in a location (e.g., bedroom or common room) where the recipient is expected to be. In this way, the user may check in on the recipient without having to disturb him or her. Check-in interface 1100 may further provide a check-in window 1115 for the recipient and one or more reminders 1125 that may be relevant to, for example, the recipient, user, and/or check-in protocol.

Optionally, in step 450, it may be determined whether another party, such as response party 145, should be notified as to the status and/or lack of responsiveness of the recipient. When another party should be notified, as may be the case when an emergency-type condition exists, then a notification to the other party may be prepared and provided to the other party (step 455). Following step 455 and/or when not notification is to be provided to another party, process 400 may end.

In some embodiments, process 400 may be implemented in, for example, a patient and/or senior care facility and the user of process 400 may be, for example, an administrator and/or an employee of the facility so that the administrator and/or an employee may check in on a plurality of recipients, seniors, and/or patients. In these embodiments, the user/administrator/employee may use, for example, a management console to view/manage a status a plurality of recipients. The management console may provide an indication of recipients that may need to be, for example, re-prompted (i.e., repeat step 415) or visited to physically determine a status.

In processes 200, 300, and 400, a notification may be sent to a user device associated with execution of the relevant process. In some embodiments, the notification may be provided to the user via a notification interface 1300 displayed by the user's device as shown in FIG. 13. Notification interface 1300 may serve as a central platform from which a user may understand various events that have occurred and the status for one or more recipients with whom a user is communicating. The recipients may each have his or her own recipient icons 1315 that serve to separate notifications for each of the recipients the user is communicating with. Notification interface 1300 may also serve as a mechanism for the response of the user to a particular notification displayed on the notification interface 1300. For example, notification interface 1300 may display a notice 1305 indicating that a recipient (in this case Robert) missed a check-in today and may also display an icon 1310 adapted to enable the user to take an action (e.g., call or send a message) corresponding to the notification (i.e., “call Robert”).

In another example, notification interface 1300 may display a reminder indicating that a message should be sent to a recipient (in this case Aretha Jackson) because it is her birthday and may also display an icon adapted to enable the user to take an action corresponding to the notification such as sending a message (indicated in FIG. 13 as “send gram”). In a further example, notification interface 1300 may display a notification pertaining to a status for message queue and/or an invitation to join a walled garden (i.e., “Rich, please connect with me on FamilyGram”).

Streams of messages, or chat streams, are useful for timely dialog between 2 (or more) users, but are not designed or intended to act as a repository of meaningful interactions for viewing at a later point in time. Instead, they are typically used for communication that is relevant at the time it is received, with that relevance being superseded by messages that come later in time. At times, SMS text messages, or other types of chat messages, exchanged between a recipient and a user, or between two users, may contain pictures, videos, text, and/or audio. Typically, these SMS text messages are displayed in a texting interface provided by a recipient and/or user device in a linearly chronological fashion.

While the texting interface, if never “cleared” of the dialog with another user, may provide a mechanism to revisit information sent in the past along with a possible contextual audio or text description, over time (e.g., weeks, months, years) the chronologically displayed messages become useless for retrieval due to the linear nature of access, which requires a recipient and/or user to have to scroll what could be hundreds of feet worth of linearly displayed messages to access a target image or other message received in the past.

Currently available methods of saving data received in a text message stream are limited to saving the text message stream (as described above) and the saving of photographs and other images in a general photo archive that may be provided by the device. This saving of photographs, however, does not enable a recipient and/or user to associate any additional information (e.g., text, an audio recording, a graphic, etc.) received via the text message stream with the photograph. As such, a recipient's “album” may contain hundreds of disorganized photos, or photos that are chronologically saved, that are all but impossible for recipient to access in a meaningful way.

Discussed herein are systems and methods for identifying EMOs or other messages that are not EMOs (e.g., pictures, text, audio recordings, etc.) within a message stream and automatically saving the EMOs in one or more albums or folders using criteria set up by the recipient and/or a user. The albums may be stored on, for example, a recipient device such as recipient device 110, a user device, such as user devices A-N 115A-N, a computer system, such as computer system 130, a data storage device, such as data storage device 135, and/or a cloud-based or Internet-enabled data storage system.

Also provided are systems and methods that enable a recipient and/or user to access, view, manipulate, play, and/or edit the saved EMOs or other messages in a convenient and intuitive way. Thus, a recipient and/or user may be able to access EMOs without having to wade through other content that may lack interest from a longitudinal historical perspective (e.g., standard text messages, routinely received notifications, etc.) that may be included in a message stream that is of little, or no, long-term value to the recipient and/or user.

Thus, the present invention provides the recipient and/or user meaningful access to EMOs received over time (e.g., weeks or years) while sparing him or her the tedium and confusion associated with manually scrolling through a chronologically presented text stream and/or generating one or more albums of EMOs. This enables the recipient and/or user to maintain connected in, for example, social and emotional ways to users (e.g., family and friends) and may serve to thereby retain and deepen a social and/or emotional connection between the recipient and/or user(s).

FIG. 5 provides a flowchart of an exemplary process 500 for extracting EMOs and/or other messages or content received via a messaging protocol from a message stream and generating/modifying/updating a data structure that stores EMOs, messages, or other content according to one or more criteria. Process 500 also provides a method for enabling a recipient and/or user of EMOs to store and/or access them in a convenient and intuitive way. Process 500 may be executed by, for example, system 100 or any component or combination of components included therein.

In step 505 one or more parameters and/or instructions for extracting EMOs, messages, and/or other content from a message stream may be received by a recipient device, such as recipient device 110. Exemplary other content includes, but is not limited to, images, photographs, text, and audio files. The parameters and/or instructions received in step 505 may be received by, for example, a recipient device, such as recipient device 105 and/or a computer system, such as computer system 130. The instructions may be received from a recipient, such as recipient 105 using the recipient device, a user, such as users A-N 115A-N using a user device A-N 120A-N, and/or a computer system, such as computer system 130.

In some embodiments, the parameters are received via a recipient's and/or user's interaction with an interface may be provided via, for example, the recipient device and/or one or more user devices. In some instances, one or more parameters and/or instructions received in step 505 may be default parameters and/or instructions executed by, for example, a software application running on the recipient device, the user device, and/or a computer system (e.g., computer system 130) in communication with the recipient device and/or the user device. The default parameters and/or instructions may be provided by, for example, the computer system and/or a software application running on the recipient and/or user device. In some instances, the parameters and/or instructions received in step 505 may include acceptance of one or more default parameters and/or instructions. Additionally, or alternatively, the received parameters and/or instructions may be automatically accepted upon, for example, installation of a software program or update to a software program on the recipient device and/or user device.

In some embodiments, the instructions received in step 505 may, for example, require determining whether a message received via a message stream has an EMO identifier or tag. In other embodiments, the instructions received via step 505 may enable a software application running on the recipient's device to assemble two or more data files received via a single message in a text messaging stream into an EMO.

Parameters and/or instructions for building, modifying, and/or updating a data structure that stores EMOs may also be received in step 505. Exemplary default parameters and/or parameters received in step 505 include instructions to organize EMOs into a plurality of folders or albums according to a characteristic of the EMO. Exemplary characteristics for an EMO include a sender of the EMO, subject matter included in the EMO, a group of recipients of an EMO, a geo-location associated with the EMO, a type of EMO, a type of data file included within the EMO, a type of media included within the EMO, etc.

At times, the parameters and/or instructions may relate to all incoming EMOs or only to and EMOs that have one or more characteristic in common. For example, a set of parameters and/or instructions may provide for the organization of all EMOs received from a particular source, or user, into a particular organizational structure (e.g., a folder or album). An alternative set of parameters and/or instructions may provide for the organization of all messages received during a certain time frame (e.g., month, year, holiday, etc.) into a particular organizational structure. The parameters and/or instructions may also provide for the organization of EMOs into multiple organizational structures so that the data structure may provide access to a particular EMO via multiple organizational structures or albums.

In step 510, an EMO, message, and/or other content may be received by, for example, the recipient device. In some embodiments, execution of step 510 may further include extraction of the received EMO, message, and/or other content from a stream of data and/or messages received by the recipient device. Exemplary streams of data include, but are not limited to, a SMS text stream and a chat stream. In some embodiments, the stream of data may be intermittently received.

In some embodiments, execution of step 510 may include extraction of EMOs, messages, and/or other content from a conversation between the recipient and one or more users. Exemplary conversations include, but are not limited to, exchanging EMOs, SMS text messages, or chat messages and the sending of email.

In some embodiments, step 510 may be executed on a message stream that has been received in the past. In this way, a recipient may curate EMOs, message, and/or other content that were previously (as opposed to instantaneously) received.

The parameters/and or instructions received in step 505 may be executed by, for example, a software application executing on the recipient device in order to, for example, determine a characteristic of the received/extracted EMO, message, and/or other content (step 515) and categorize the EMO, message, and/or other content using the determined characteristic (step 520). Exemplary characteristics of the received/extracted EMO, message, and/or other content include, but are not limited to, a sender of the EMO, message, and/or other content, a group of users and/or recipients who also received the received/extracted EMO, message, and/or other content, subject matter included in the EMO, message, and/or other content, an event that may be mentioned in the EMO, message, and/or other content, and/or a type of data file included in the EMO, message, and/or other content. In some instances, execution of step 515 may include use of, for example, photo, face, and/or audio recognition to determine one or more characteristics (e.g., who is in a picture or who is speaking in an audio file) of the received/extracted EMO, message, and/or other content.

A data structure may then be built, modified, and/or updated so that the received EMO, message, and/or other content may be stored and/or associated with the appropriate category/categories or parameter(s) (i.e., folder or album) (step 525). The data structure may be partially, or wholly, stored on, for example, the recipient device, a remote storage device (such as a backup hard drive, a flash drive, or other data storage device), a remote storage device operated by a third party as may be the case with cloud storage, or some combination thereof.

In some instances, a portion of the data structure may be built following step 505, and prior to execution of steps 510-520, in response to the received parameters and/or instructions. For example, a general organizational structure for the data structure may be established upon receipt of the parameters and/or instructions without the need to receive any EMOs, messages, and/or other content (step 515) or determine any characteristics of the received EMOs, messages, and/or other content (step 520).

Then, in step 530, the recipient and/or user may be provided with an access mechanism for accessing the data structure and/or EMOs, message, and/or other content stored in the data structure. The access mechanism may provide, for example, labels, icons, and/or thumbnail images by which a recipient may identify a particular category/album and execute an action (e.g., touch or click on the thumbnail image) to access the EMOs, messages, and/or other content in the data structure associated with the accessed category/album.

In some embodiments, the access mechanism may be provided to the user on one or more user devices so that, for example, a user may remotely access the data structure and/or a portion thereof in order to, for example, edit parameters and/or instructions for building/modifying/updating the data structure, access data stored in the data structure, delete data from the data structure, and/or copy data from the data structure.

In one embodiment, the access mechanism may be provided via an interface such as album selection interface 1600 displayed on, for example, the recipient device, as shown in FIG. 16. The album selection interface 1600 displays a plurality of selectable icons, each of which may be enabled to provide access to a different album or category of EMO, message, and/or other content.

In step 535, selection of an EMO, or an album that stores EMOs organized according to one or more parameters received in step 505, stored in the data structure may be received via, for example, the access mechanism provided in step 530. In an exemplary embodiment, the selection of step 535 may be received by, for example, user selection of an icon displayed on an interface of the recipient device, such as interface 1600 of FIG. 16. In another exemplary embodiment, the selection of step 535 may be made by way of a voice command spoken into, for example, a recipient and/or user device. Exemplary voice commands may be “show me pictures from 2015” or “show me an EMOs from my son.”

Then, in step 540, the selected EMO, message, other content, and/or album may be provided to the recipient. In most cases, the selected EMO, message, and/or other content will be provided to the recipient via a display and/or speaker of the recipient device. FIG. 17 provides an exemplary album interface 1700 that shows all of the EMOs associated with a particular album, in this case the “Demetrius's EMOs” album, as may be provided via execution of step 540 via selection of the “Demetrius's EMOs” icon provided in album selection interface 1600. FIG. 18 provides an example of an EMO 1800 that has been stored in the data structure 1800 that is displayed upon selection of icon/image displayed on the upper left hand corner of album interface 1700.

In another embodiment, the access mechanism for EMOs may be provided via a contact interface, an example of which is provided by contact interface 1400 as shown in FIG. 14. Contact interface 1400 operate to provide an indication to a recipient that he or she has received an EMO from one or more of his or her contacts. Contact interface 1400 may also operate to organize communication by various categories (in this case by sender) so that messages associated with a category may be easily accessed via selection of a category's icon 1410. In some embodiments, contact interface 1400 may provide a new EMO icon for one or more of the contacts, or users A-N 115A-N who are members of the recipient's walled garden, such as walled garden 125. In the embodiment of FIG. 14, the recipient, in this case a woman named Delores, has received new EMOs from two users (i.e., Richard and Mary) and selection of the new EMO icon 1405 may provide the recipient with access to the EMO associated with the respective new EMO icon 1405.

Thus, a process for organizing received EMOs into useful categories for the recipient so that they may be efficiently, easily, and meaningfully accessed by the recipient at a later time has been herein described.

In some embodiments, execution of one or more of the processes (or a portion thereof) described herein may be automatic and/or may run as a background process without requiring any further action to be taken by the recipient and/or user.

FIGS. 19-28 provide various exemplary graphic user interfaces (GUIs) 1900, 2000, 2100, 2200, 2300, 2400, 2500, 2600, 2700, and 2800, respectively, showing various aspects of a landing page of an EMO software application running on a recipient device, such as recipient device 110.

Each of the GUIs 1900, 2000, 2100, 2200, 2300, 2400, 2500, 2600, 2700, and 2800 display a number of static icons that maintain their size, shape, and location regardless of other icons or activity that may be displayed thereon. For example, GUIs 1900, 2000, 2100, 2200, 2300, 2400, 2500, 2600, 2700, and 2800 provide a static favorites icon 1905, a static settings icon 1910, and a static EMO access icon 1915. The recipient may access one or more favorite, for example, software applications or features of his or her recipient device via selection of favorites icon 1905. The recipient may access one or more device settings via selection of settings icon 1910. The recipient may access the EMO software program via selection of EMO access icon 1915.

The GUIs of FIGS. 19-28 provide dynamic icons of four different states, referred to herein as state 0, state 1, state 2, and state 3. The size of each of these icon states is different when displayed on the landing page with the size of state 0 icons being the smallest, state 1 icons being larger than state 0 icons, state 2 icons being larger than state 1 icons, and state 3 icons being the largest in size. Although the state 0, 1, 2, and 3 icons of FIGS. 19-28 are all shown to be circular in shape, this need not be the case as the present disclosure contemplates other shapes for icons including, but not limited to, squares, diamonds, triangles, stars, etc. Additionally, or alternatively, a state for an icon may be indicative of the shape and/or color of the icon. For example, in some embodiments, a state 0 icon may be a small square, a state 1 icon may be a large square, a state 2 icon may be a small triangle, and a state 3 icon may be a large star.

In some embodiments, a state of an icon may be represented on the landing page using animation or other visual effects. For example, a state 0 icon may be flashing, a state 1 icon may be changing colors, a state 2 icon may include a halo, and a state 3 icon may include an animated clip.

FIG. 19 provides a GUI 1900 with a nearly blank landing page with the exception of a state 0 icon 1920. A state 0 icon 1920 may be displayed on a landing page and, in some instances, may serve as a marker for the display of a state 1 icon 1925 as shown in GUI 2100 of FIG. 20, a state 2 icon 1930 as shown in GUI 1901 of FIG. 21, and/or a state 3 icon 1935 as shown in GUI 2200 of FIG. 22. Typically, state 0 icons 1920 do not include any information visible to the recipient and, in some embodiments, state 0 icons 1920 are not displayed on a landing page in a manner for the recipient to see. For example, state 0 icons 1920 may be presented on a landing page so that they blend in, or are otherwise indistinguishable from, an interface provided by the recipient's device.

State 1 icons 1925, state 2 icons 1930, and state 3 icons 1935 may provide an indication of content included in a content screen (not shown) that is associated with the respective state 1 icons 1925, state 2 icons 1930, and state 3 icons 1935. Selection of a particular state 1 icon 1925, state 2 icon 1930, and/or state 3 icon 1935 may initiate display of a content screen associated with the particular selected icon. Exemplary indications include messages, images, or instructions. In some instances, a particular state 1 icon 1925, state 2 icon 1930, and/or state 3 icon 1935 may provide an indication that an EMO has been received and activation of the particular icon may initiate display of the EMO.

In some embodiments, the indication may provide information about an event the recipient is invited to or an interest of the recipient. The content associated with the indications may be sourced from, for example, a user, such as users A-N 115A-115N and/or a third party data source, such as third party data source 150. For example, state 1 icon 1925, state 2 icon 1930, and/or state 3 icon 1935 may provide an indication of a news event, a weather condition, an available entertainment option, and/or an event reminder.

In some instances, state 1 icon 1925, state 2 icon 1930, and/or state 3 icon 1935 may provide information saved locally on the recipients device. For instance, a state 1 icon 1925, state 2 icon 1930, and/or state 3 icon 1935 may provide a reminder of an event placed on a recipient's calendar or may provide an indication of a photograph saved on the recipient's device.

On some occasions, a state 1 icon 1925, state 2 icon 1930, and/or state 3 icon 1935 and/or a content screen that is, or will be, associated with an icon may be set up by the recipient and/or a user. For example, a recipient and/or user may request that a content screen providing a calendar reminder, a weather update, a request to log onto a software program, or a news update may be associated with an icon for display on the landing page.

In most embodiments, the content screen associated with a particular icon will remain the same as the icon cycles through the state 1, state 2, and state 3 phases. For example, the state 1 icon 1920 of GUI 2000 is associated with an EMO regarding a seaside brunch and the icon displays a photograph as well as text. In GUI 2100, an icon for the same content screen is displayed as a state 2 icon 1930 and in GUI 2200, an icon for the same content screen is displayed as a state 3 icon 1935.

The progression of GUIs 1900, 2000, 2100, 2200, 2300, 2400, 2500, 2600, 2700, and 2800 show an example of how the display of state 1 icon 1925, state 2 icon 1930, and/or state 3 icon 1935 on the landing page evolves over time with icons changing in size and, on some occasions, position. For example, GUI 1900 provides a landing page with a single state 0 icon 1920 displayed at the center. In GUI 2000, a landing page with a single state 1 icon 1925 is provided. The state 1 icon 1925 is of first size and displays a picture as well as some text that is associated with a content screen. In GUI 2100, the content of the icon of GUI 2000 is provided as a state 2 icon 1930 and is, in this instance, larger that the state 1 icon 1925 of GUI 2000. Additionally, two new state 0 icons 1920 are provided on GUI 2100.

GUI 2200 provides a state 3 icon 1935 in place of the state 2 icon 1930 of GUI 2100 and two state 1 icons 1925 in place of the two state 0 icons of GUI 2100. GUI 2200 also introduces a new state 0 icon 1920.

GUI 2300 provides the state 3 icon 1935 of GUI 2200 and provides 2 state 2 icons 1930 in place of the two state 1 icons 1930 of GUI 2200. GUI 2300 also provides one state 1 icon 1925 in place of the one state 0 icon 1920 of GUI 2200 and introduces a new state 0 icon 1920.

GUI 2400 provides the state 3 icon 1935 of GUI 2200 and 2300 and provides the same two state 2 icons 1930 of GUI 2300. GUI 2400 also provides one state 2 icon 1930 in place of the one state 1 icon 1925 of GUI 2300, provides one state 1 icon 1925 in place of the one state 0 icon 1920 of GUI 2300 and introduces a new state 0 icon 1920.

GUI 2500 provides the state 3 icon 1935 and state 2 icons of GUI 2400, provides one state 2 icon 1930 in place of the one state 1 icon 1925 of GUI 2400, provides the state 0 icon of GUI 2400, and introduces a new state 0 icon 1920.

GUI 2600 changes the state 3 icon 1935 of GUI 2500 into a state 2 icon 1930, changes one of the state 2 icons 1930 of GUI 2500 into a state 3 icon 1935, provides three of the state 2 icons 1930 of GUI 2500 and provides the two state 0 icons 1920 GUI 2500.

GUI 2700 changes the state 3 icon 1935 of GUI 2600 into a state 2 icon 1930, changes one of the state 2 icons 1930 of GUI 2600 into a state 3 icon 1935, provides three of the state 2 icons 1930 of GUI 2600 and provides the two state 0 icons 1920 GUI 2500.

GUI 2800 provides a new state 3 icon 1935, changes the state 3 icon 1935 of GUI 2700 into a state 2 icon 1930 provides three of the state 2 icons 1930 of GUI 2700 and provides the two state 0 icons 1920 GUI 2700.

It is important to note that the position of state 0 icons 1920, state 1 icons 1925, state 2 icons 1930, and/or state 3 icons 1935 on a landing page changes over time, as can be seen in the GUI of FIGS. 19-28. For example, one or more state 0 icons 1920, state 1 icons 1925, state 2 icons 1930, and/or state 3 icons 1935 may be repositioned in response to, for example, a change of a icon from one state to another or in response to an action by the recipient (e.g., touching or tilting the recipient device).

The changing state and/or position of a particular icon on a GUI or landing page may be time dependent. For example, a state of a particular icon may change on a periodic or randomly timed basis. In some instances, the rate of change of state for a particular icon may be associated with a rate of change for another icon on the landing page. In this way, for example, displaying all icons on a particular landing page as a state 3 icon 1935 may be avoided.

We claim:

1. A method comprising:
receiving content for a plurality of messages from a user, the messages being compatible with a messaging communication protocol;
generating a queue of messages using the received content;
determining whether a message from the message queue is to be communicated to a recipient; and
communicating a message from the message queue to the recipient.

2. The method of claim 1, further comprising:
receiving instructions regarding when to send a message included in the queue to the recipient, wherein the determination is responsive to the received instructions.

3. The method of claim 1, wherein the message is an enriched media object, the enriched media object including a first data file and a second data file encapsulated together into a single object.

4. The method of claim 1, further comprising:
determining a status for the message queue; and
communicating the status to the user.

5. The method of claim 1, further comprising:
determining a status for the message queue;
communicating the status to the user;
receiving, from the user, at least one of instructions to replenish queue and new content for one or more new messages to be added to the queue.

6. The method of claim 1, wherein the received content is an instruction to retrieve content from a third party data source.

7. The method of claim 1, further comprising:
receiving an indication of a triggering event from a third party data source, wherein the determination is responsive to the indication.

8. The method of claim 1, further comprising:
building a data structure that includes the generated queue of messages using the received content.

9. The method of claim 1, wherein the determination further comprises determining when to communicate the message to the recipient.

10. The method of claim 1, wherein the determination further comprises establishing a base event and communicating the message upon occurrence of the base event and expiration of a pseudo-randomly determined time period.

11. A method comprising:
receiving instructions for the auto-generation of a plurality of messages to be communicated to a recipient via a message communication protocol;
receiving instructions regarding a triggering event for the generation and communication of an auto-generated message;
automatically generating the message responsively to occurrence of the triggering event; and
communicating the auto-generated message to the recipient via the message communication protocol.

12. The method of claim 11, wherein the message is an enriched media object, the enriched media object including a first data file and a second data file encapsulated together into a single object.

13. The method of claim 11, wherein content for the automatically generated message is retrieved from a third party data source.

14. The method of claim 11, further comprising:
establishing a base event prior to the communication of the auto-generated message to the recipient; and
communicating the auto-generated message upon occurrence of the base event and expiration of a pseudo-randomly determined time period.

15. A method comprising:
receiving content for a plurality of reminders from a user, the reminders serving to remind a user to communicate with a recipient via a recipient device;
generating a queue of reminders using the received content;
determining whether a reminder from the reminder queue is to be communicated to the user; and
communicating the reminder from the reminder queue to the user.

16. The method of claim 15, wherein content included in the reminder is retrieved from a third party data source.

17. The method of claim 15, further comprising:
establishing a base event prior to the communication of the reminder to the user; and
communicating the reminder upon occurrence of the base event and expiration of a pseudo-randomly determined time period.
